(19) United States
(12) Patent Application Publication
(10) Pub. No.: US 2026/0225621 A1
(43) Pub. Date: Aug. 6, 2026

(54) System(s) for Validating 2D and 3D LiDAR Data on an Autonomous Vehicle

(71) Applicant: Autonomous Solutions, Inc., Mendon, UT (US)

(72) Inventors: Taylor Bybee, Mendon, UT (US); Darren Herbst, Mendon, UT (US); Robert Ashby, Mendon, UT (US); Jeff Ferrin, Mendon, UT (US); Benjamin Call, Mendon, UT (US)

(73) Assignee: Autonomous Solutions, Inc., Mendon, UT (US)

(21) Appl. No.: 19/344,504

(22) Filed: Sep. 29, 2025

Related U.S. Application Data
(60) Provisional application No. 63/753,944, filed on Feb. 5, 2025.

(51) Int. Cl. B60W 60/00; A01B 76/00; G01S 7/497; G01S 17/88

(52) U.S. Cl. CPC B60W 60/00186; A01B 76/00; G01S 7/497; G01S 17/88; B60W 2420/408

(57) ABSTRACT

Disclosed are autonomous vehicles and processes for verifying LiDAR signal data before relying on the visual sensors to navigate the autonomous vehicle through the operating environment and autonomous vehicles and processes for accurately determining implement position and/or orientation before continuing to operate the implement within the operating environment. The LiDAR signal data may be verified by looking for expected noise in the signal data, by observing expected movement of an implement, or by comparing an odometry dataset based on the LiDAR signal data to GPS and/or wheel speed data of the autonomous vehicle. The implement may be autonomously operated based on an implement sensor signal that may be verified by comparing implement sensor signal data to corresponding LiDAR signal data (e.g., when adjusting the position and/or orientation of the implement) or based on primarily relying on the LiDAR signal data to confirm the position and/or orientation of the implement.

### BACKGROUND

Safety-rated LiDAR sensors exist which, because of their rigorous testing and adherence to specific standards and regulations, provide increased reliability and are desired in applications where safety of persons and equipment are tantamount. Such LiDAR and other safety-rated sensors may be relied upon to navigate autonomous vehicles where safety and operational efficiency are critical.

### SUMMARY

Disclosed are autonomous vehicles and processes for driving autonomous vehicles. In particular, disclosed are processes for verifying the reliability of visual sensor signal data collected by sensors of an autonomous vehicle system. The autonomous vehicle may comprise a steering control system for autonomously controlling a driving direction of the autonomous vehicle, a speed control system for autonomously controlling a speed of the autonomous vehicle and one or more sensors. The sensor may include a visual sensor, such as a LiDAR sensor, a radar sensor, or a stereo camera. The autonomous vehicle may include one or more processors communicatively coupled with the one or more sensors, the steering control system, and the speed control system, and may include one or more computer-readable media having stored thereon instructions that when executed implement a process that cause the one or more processors to verify the reliability of at least one visual sensor.

In an embodiment, the visual sensor signal data may be verified by looking for signal noise through a comparison of visual sensor (e.g., LiDAR sensor) signal data collected at different moments. Specifically, the process may include, at a first time, receiving first visual sensor signal data in predetermined time packets from the visual sensor, wherein a sensor field of view of the visual sensor includes a static surface of an operating environment and/or the autonomous vehicle, and, at a second time, receiving second visual sensor signal data in predetermined time packets from the visual sensor. The instructions may further include calculating a LiDAR reliability value associated with the visual sensor by comparing the first visual sensor signal data and the second visual sensor signal data, wherein the sensor reliability value represents a degree of difference between at least a portion of the static surface indicated by the first and second visual sensor signal data, and then, when the LiDAR reliability value is greater than or equal to a reliability threshold, instruct the steering control system and the speed control system to drive the autonomous vehicle along a path through the operating environment using the first and/or second visual sensor signal data, and, when the LiDAR reliability value is less than the reliability threshold, instruct the autonomous vehicle to enter a low-risk state. In some embodiments, the instructions may further comprise illuminating the static surface with a pulsating light.

In another embodiment, the visual sensor signal data (e.g., LiDAR signal data) may be verified by detecting a change in position and/or orientation of a vehicle implement observed by the visual sensor, such as a LiDAR sensor. The process may include, at a first time, receiving first LiDAR signal data in predetermined time packets from a LiDAR sensor, wherein the implement is within a sensor field of view of the LiDAR sensor and wherein the first LiDAR signal data indicates a position and/or orientation of the implement. Then, at a second time, instructing the steering control system, the speed control system, and/or the implement control system to adjust the position and/or orientation of the implement. The instructions may then include, at a third time, receiving second LiDAR signal data in predetermined time packets from the LiDAR sensor, wherein the second LiDAR signal data indicate the position and/or orientation of the implement. The instructions may further comprise calculating a LiDAR reliability value associated with the LiDAR sensor by comparing the first LiDAR signal data and the second LiDAR signal data, wherein the LiDAR reliability value represents a degree of difference between the first and second LiDAR signal data, and, when the LiDAR reliability value is greater than or equal to a reliability threshold, instruct the steering control system and the speed control system to drive the autonomous vehicle along a path through an operating environment based on the first LiDAR signal data and/or the second LiDAR signal data, and, when the LiDAR reliability value is less than the reliability threshold, instruct the autonomous vehicle to enter a low-risk state.

The implement may comprise a reflective surface to aid the visual sensor in detecting the implement. The position and/or orientation of the implement may be determined based on a shadow of the implement indicated within the first and second LiDAR signal data. The process may further include selecting a path through the operating environment based on the position and/or orientation of the implement.

The process may further include, when the sensor reliability value is greater than or equal to the reliability threshold, selecting a path through the operating environment based on the position and/or orientation of the implement or instructing the implement control system to adjust a position and/or orientation of the implement based on a selected path of the autonomous vehicle.

The process may further include instructing the implement control system to adjust the position of the implement in and out of the sensor field of view. The LiDAR reliability value of the LiDAR sensor may then be adjusted, such that when the implement is within a sensor field of view of the LiDAR sensor and the sensor signal data indicates that the implement is within the sensor field of view, the LiDAR reliability value is increased, and when the implement is within the sensor field of view and the sensor signal data indicates that the implement is not within the sensor field of view, the LiDAR reliability value is decreased. The LiDAR reliability value may additionally, or alternatively, be adjusted, such that when the implement is not within the sensor field of view and the sensor signal data indicates that the implement is within the sensor field of view, the LiDAR reliability value is decreased, and when the implement is not within the sensor field of view and the sensor signal data indicates that the implement is not within the sensor field of view, the LiDAR reliability value is increased.

In another embodiment, the LiDAR signal data may be verified by comparing an odometry dataset based on the LiDAR signal data to a GPS and/or wheel speed dataset of the autonomous vehicle. The process may include receiving point cloud data from a LiDAR sensor, calculating a first dataset based on the point cloud data, wherein the first dataset comprises an odometry dataset that indicates at least one of a velocity, a velocity history, or a location of the autonomous vehicle. The process may include receiving a second dataset, wherein the second dataset comprises a GPS dataset and/or a wheel speed dataset and wherein the second dataset indicates at a velocity, velocity history, and/or location of the autonomous vehicle that corresponds to the velocity, velocity history, and/or location of the autonomous vehicle of the first dataset. The process may then comprise calculating a LiDAR reliability value associated with the LiDAR sensor by comparing the odometry dataset with a GPS dataset and/or a wheel speed dataset of the autonomous vehicle, wherein the LiDAR reliability value represents a degree of difference between corresponding data within the first and second datasets. The process may further include, when the LiDAR reliability value is greater than or equal to a reliability threshold, instructing the steering control system and the speed control system to drive the autonomous vehicle along a path through an operating environment based on the point cloud data, and, when the LiDAR reliability value is less than the reliability threshold, instructing the autonomous vehicle to enter a low-risk state.

The point cloud data may be produced from LiDAR sensor observation of a ground surface of the operating environment or of a drive wheel of the autonomous vehicle. The process may further comprise calculating a wheel speed based on first and second LiDAR signal data, and instructing the steering control system and the speed control system to drive the autonomous vehicle along a path through the operating environment based on the wheel speed.

Calculating the LiDAR reliability value (e.g., in any of the above processes) may include comparing the first LiDAR signal data and the second LiDAR signal data, such as comparing a checksum of the first LiDAR signal data to a checksum of the second LiDAR signal data. Calculating the LiDAR reliability value may further comprise identifying a repeating pattern of sensor signal frames within the first and/or second LiDAR signal data.

Entering the low-risk state may comprise instructing the speed control system to stop the autonomous vehicle, instructing the speed control system to slow a velocity of the autonomous vehicle, or sending a notification to a remote operator, such as a camera image of the implement or the operating environment.

Also disclosed are autonomous vehicles and processes for driving and/or operating autonomous vehicle and/or implements. Specifically, the autonomous vehicle and processes may be configured to verify the reliability of control over the implement of an autonomous vehicle-to verify the degree of confidence of control an implement control system of the autonomous vehicle maintains in operating the implement. The autonomous vehicles and processes disclosed herein may be used to verify the position, orientation, and/or operation of the implement.

The autonomous vehicle, similar to that described above, may comprise a steering control mechanism, a speed control system, and one or more sensors. The sensors may comprise a LiDAR sensor, such as a 3D or a 2D LiDAR sensor. The autonomous vehicle may further comprise an implement control system. The autonomous vehicle may include one or more processors communicatively coupled with the one or more sensors, the steering control system, the speed control system, and the implement control system, and may include one or more computer-readable media having stored thereon instructions that when executed implement a process that cause the one or more processors to verify the operational confidence of the autonomous vehicle system over the implement.

In an embodiment, the process may comprise instructing an implement control system of the autonomous vehicle to adjust a position and/or orientation of an implement to an expected position and/or orientation and receiving LiDAR signal data from a LiDAR sensor, wherein the LiDAR signal data indicates a position and/or orientation of the implement. The process may further include calculating an implement confidence value associated with the implement based on an expected position and/or orientation of the implement and the LiDAR signal data, a degree of difference between the expected position and/or orientation of the implement and the position and/or orientation of the implement indicated by the LiDAR signal data. When the implement confidence value is greater than or equal to a confidence threshold, the implement control system may operate the implement within an operating environment based on the LiDAR signal data, and when the implement confidence value is less than the confidence threshold, the implement control system may enter a low-risk state.

The process may further comprise, at a first time, receiving first LiDAR signal data from the LiDAR sensor, wherein the first LiDAR signal data indicates the implement is in a first position and instructing the implement control system to adjust the position of the implement from the first position to a second position, and, at a second time, receiving second LiDAR signal data from the LiDAR sensor, wherein the second LiDAR signal data indicates that the implement is in the second position, and calculating an implement confidence value associated with the implement based on the expected position of the implement, the first LiDAR signal data, and the second LiDAR signal data.

Additionally, or alternatively, the process may further comprise instructing the implement control system to adjust the position of the implement in and out of a sensor field of view of the LiDAR sensor. The implement confidence value of the implement may then be adjusted such that when the implement is within the sensor field of view of the LiDAR sensor and the LiDAR signal data indicates that the implement is within the sensor field of view, increasing the implement confidence value, and when the implement is within the sensor field of view and the LiDAR signal data indicates that the implement is not within the sensor field of view, decreasing the implement confidence value. The implement confidence value may also be adjusted such that when the implement is not within the sensor field of view and the sensor signal data indicates that the implement is within the sensor field of view, decreasing the implement confidence value, and when the implement is not within the sensor field of view and the sensor signal data indicates that the implement is not within the sensor field of view, increasing the implement confidence value.

In another embodiment, the process may comprise receiving implement sensor signal data from the implement sensor via the implement control system, wherein the implement sensor signal data indicates a position and/or orientation of the implement, and receiving LiDAR signal data from the LiDAR sensor, wherein the implement is within a sensor field of view of the visual sensor and wherein the LiDAR signal data indicates the position and/or orientation of the implement. The process may further comprise calculating an implement confidence value associated with the implement based on the implement sensor signal data and the LiDAR signal data, wherein the implement confidence value represents a degree of difference between the position and/or orientation of the implement indicated by the implement sensor signal data and the position and/or orientation of the implement indicated by the LiDAR signal data. Then, when the implement confidence value is greater than or equal to a confidence threshold, the implement control system may operate the implement within an operating environment based on the implement sensor signal data and/or the LiDAR signal data, and, when the implement confidence value is less than the confidence threshold, the implement control system may enter a low-risk state.

The implement sensor signal data may be produced from a position sensor, a proximity sensor, an inertial sensor, a force sensor, or a torque sensor. The LiDAR signal data may indicate the position and/or orientation of the implement based on a shadow of the implement. The implement may connect to the autonomous vehicle, and the position and/or orientation of the implement may be indicated by LiDAR signal data received from additional visual sensors connected to a second autonomous vehicle positioned within the operating environment.

The implement may comprise a mower reel, a mower rotary blade, a shovel, a tractor planter, a tractor seed drill, a tractor rotavator, a tractor spreader, a tractor mower, a tractor harvester, a backhoe, a bale grabber, a forklift, a land leveler attachment, a dump bed, or a boom and bucket. The visual sensor signal data (e.g., LiDAR signal data) may indicate a position and/or orientation of a steering wheel or a drive wheel (e.g., in place of the implement). The position and/or orientation of the steering wheel indicated by the visual sensor signal data may be compared to the position and/or orientation of the steering wheel indicated by implement sensor signal data (e.g., via a steering angle sensor) to calculate the implement confidence value. The steering control system may then be instructed to steer the autonomous vehicle based on the implement confidence value.

Entering the low-risk state comprises instructing the implement control system to prevent movement of the implement and/or instructing the implement control system to return the implement to a closed and/or home position. Entering the low-risk state may additionally, or alternatively, comprise sending a notification to a remote operator. The notification may comprise a camera image of the implement. When the implement confidence value is less than the confidence threshold, the autonomous vehicle may, additionally or alternatively, enter the low-risk state, similar as described above.

Also disclosed is an autonomous vehicle comprising an autonomous mower. The autonomous mower may comprise a mower reel configurable between an elevated position and a lowered position. The autonomous mower may further comprise a steering control system for autonomously controlling a driving direction of the autonomous mower, a speed control system for autonomously controlling a speed of the autonomous mower, and a reel control system in communication with the mower reel. The autonomous mower may comprise one or more sensors, including a LiDAR sensor, one or more processors communicatively coupled with the one or more sensors, the steering control system, the speed control system, and the reel control system, and one or more computer-readable media having stored thereon instructions for a process to verify the position and/or orientation of the mower reel. The process can include instructing the reel control system to adjust a position of the mower reel, receiving LiDAR signal data in predetermined time packets from the LiDAR sensor, wherein the LiDAR signal data indicates the position of the mower reel, and calculating an implement confidence value associated with the mower reel based on an expected position of the mower reel and the LiDAR signal data, wherein the implement confidence value represents a degree of difference between the expected position of the implement and the position of the implement indicated by the LiDAR signal data. When the implement confidence value is greater than or equal to a confidence threshold, the reel control system may operate the mower reel within an operating environment based on the LiDAR signal data, and when the implement confidence value is less than the confidence threshold, the reel control system may enter a low-risk state.

The process may further include, at a first time, receiving first LiDAR signal data from the LiDAR sensor, wherein the first LiDAR signal data indicates the reel is in a first position of the elevated and lowered positions, instructing the reel control system to adjust a position of the reel from the first position to a second position of the elevated and lowered positions, and, at a second time, receiving second LiDAR signal data from the LiDAR sensor, wherein the second LiDAR signal data indicates that the reel is in the second position. The process may then include calculating a reel confidence value associated with the reel based on the expected position of the mower reel and based on the first LiDAR signal data and the second LiDAR signal data. The autonomous mower may comprise one or more front reel assemblies and one or more intermediate reel assemblies.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 is a perspective view of an autonomous mower according to some embodiments.

FIG. 2 shows a flowchart of a process for verifying sensor signal data.

FIG. 3 is a front view of a steering wheel that may form part of an autonomous vehicle system.

FIG. 4 illustrates an autonomous tractor connected to an implement comprising an adjustable spray implement.

FIG. 5 illustrates the autonomous tractor of FIG. 4 wherein the adjustable spray implement is in a compact configuration.

FIG. 6 illustrates a flowchart of a process for verifying sensor signal data.

FIG. 7 shows a rear end of an autonomous tractor comprising visual sensors positioned to sense surfaces of the autonomous vehicle as well as the operating environment.

FIG. 8 illustrates the autonomous tractor of FIG. 7 within an operating environment.

FIG. 9 shows a flowchart of a process for verifying implement position and/or orientation.

FIG. 10 illustrates a flowchart of a process for verifying implement position and/or orientation.

FIGS. 11A-11B illustrate a cross-sectional outline view of an autonomous mower that comprises a front reel assembly in an elevated and lowered position, respectively.

FIGS. 12A-12B illustrate a cross-sectional outline view of an autonomous mower that comprises a front reel assembly and an intermediate reel assembly in an elevated and lowered position, respectively.

FIG. 13 shows an illustrative computational system for performing functionality to facilitate implementation of embodiments described in this document.

FIG. 14 illustrates a block diagram of an example autonomous vehicle communication system of the present disclosure.

FIG. 15 is a side view of an autonomous yard truck according to some embodiments.

FIG. 16 is a side view of an autonomous tractor according to some embodiments.

### DETAILED DESCRIPTION

Autonomous vehicle systems rely on exteroceptive, visual sensors to navigate an operating environment. For example, 2D or 3D scanning technologies can be used to generate a point cloud map or other representation of a sensor field of view within an operating environment. Visual sensors may not always produce sensor signal data that accurately describes the operating environment. Visual sensors may, for reasons not always known, reproduce sensor signal data or images previously recorded (i.e., stale sensor signal data) or may have unknown or large latencies in providing data. For example, visual sensors may send the same sensor signal data repeatedly or may send a pattern of repeating sensor signal data (e.g., due to faults in sensor hardware and/or errors in sensor software). In other instances, communication hardware between the visual sensors and processors of autonomous vehicle systems may cause repeating sensor signal data to be sent or problems with computing device components employed in the autonomous vehicle system may cause repeating sensor signal data to be received. For example, the network over which the sensor signal data is sent may duplicate the signals and/or the operating system of the autonomous vehicle system may not service the sensor signal data in a sufficiently timely manner. Current conventional autonomous vehicle systems lack adequate means to manage these problems.

Disclosed herein are processes for identifying stale sensor signal data. The process may include modifying behavior of the autonomous vehicle system based on a sensor reliability value (e.g., a LiDAR reliability value). The sensor reliability value may indicate the likelihood that data sent by the visual sensors is not stale and may be relied upon to navigate the autonomous vehicle. The processes may include calculating the sensor reliability value based on identification of noise and/or environmental interference between successive data frames of sensor signal data directed at static surfaces, such as static surfaces in the operating environment or of the autonomous vehicle itself. The processes may further include lighting or illuminating the static surfaces with a pulsating light. The processes may include calculating the sensor reliability value based on identification of movement of an autonomous vehicle implement within the sensor field of view, or movement of the autonomous vehicle implement in and out of the sensor field of view. The processes may include calculating the sensor reliability value based on an odometry dataset based on sensor signal data collected from the visual sensor and then comparing the odometry dataset with a GPS and/or wheel speed dataset associated with the autonomous vehicle.

Another problem in navigating autonomous vehicles arises in determining the position of vehicle implements. While autonomous vehicles may include one or more implement sensors to determine the position, orientation, and/or modes of vehicle implements, such sensors are not always reliable. Increased reliability regarding implement position, orientation, and function could decrease collision occurrence and improve navigation and operational efficiency.

These improvements may be realized by cross-checking implement sensor signal data and operating instructions for controlling the implement with visual sensor signal data collected by the visual sensors. That is, visual sensors may verify the position, orientation, and/or function of one or more vehicle implements and enable the autonomous vehicle system to operate with greater reliability.

As used herein, the term “autonomous vehicle” may refer to a vehicle that may be driven without the direct supervision of an operator.

As used herein, term “drive” or related terms (e.g., “driving the autonomous vehicle) may refer to operating (e.g., autonomously) one or more sub-systems of the autonomous vehicle. Driving the autonomous vehicle may include operating the speed control system or braking control system to move the autonomous vehicle through an operating environment. Driving the autonomous vehicle may additionally, or alternatively, include operating an implement control system (as discussed more fully below) to adjust a position or configuration of an implement of the autonomous vehicle, without regard to movement of the autonomous vehicle through the operating environment.

As used herein, the term “implement” may refer to a device connected to or in communication with the autonomous vehicle provided to enable the autonomous vehicle to perform a particular task. The implement may be configured to interface between the autonomous vehicle and the operating environment. For example, the implement may comprise a rotary blade or a reel blade of an autonomous mower, or the reel blade assembly of the autonomous mower. The implement may be an implement of an autonomous tractor, such as a set of tractor loader arm and bucket, a bale spear, a sprayer, a plow, or other tractor attachments, including mechanized tractor attachments. The implement may comprise a boom and bucket of a utility vehicle, an attachment arm, or a trailer.

The implement may also refer to a device that can be adjusted based on operational instructions for controlling other components of the autonomous vehicle. While not considered an implement in conventional usage, other adjustable surfaces of the autonomous vehicle, such as a steering wheel or a drive wheel of the autonomous vehicle, can be used in place of an implement throughout the description, where appropriate (e.g., a steering wheel might be used in place of an implement in examples referring to a sensor disposed towards the top of an autonomous vehicle in which the steering wheel may be within the sensor field of view, but may generally not apply to examples referring exclusively to sensors disposed beneath the autonomous vehicle where the steering wheel would generally be outside the sensor field of view).

As used herein, the term “operating environment” may refer to a location in which the autonomous vehicle is operated, particularly the vicinity in which a specific task is to be completed by the autonomous vehicle.

As used herein, the term “sensor” may refer to “visual sensors” or to “implement sensors.” The term “visual sensor” may refer to devices configured to detect surfaces of the operating environment to aid in navigating the autonomous vehicle and/or devices configured to detect surfaces of the autonomous vehicle itself. Visual sensors may include LiDAR, radar, and/or video cameras (stereo cameras), or other sensors used to map or otherwise create representations of the operating environment and/or the autonomous vehicle. The video cameras, for example, may include 360 degree cameras, a front facing camera, and/or a back facing camera.

The term “implement sensor” may refer to sensors configured to measure parameters associated with an implement. Implement sensors may not be configured to produce a visual representation of the operating environment. Implement sensors may include devices configured to measure parameters of the autonomous vehicle, such as engine speed, wheel speed, engine temperature, or other parameters. Implement sensors may comprise electromechanical, hydraulic, or piezoelectric, or other sensors.

As used herein, the term “sensor field of view” (FOV) may refer to a portion of the operating environment that is within the un-occluded view of a visual sensor.

As used herein, the terms “stale data” or “stale signal” may refer to outdated or irrelevant information within a system, particularly in the context of real-time data or sensor signal data. Stale data may arise when data has not been updated or refreshed, making it inaccurate or not reflecting current conditions.

As used herein, the term “signal frame,” “frame,” or related terms may refer to a single, discrete unit of data captured by the sensor (e.g., the visual sensor) at a specific point in time.

As used herein, the term “noise” may refer to often unwanted variations or random fluctuations in a sensor's output signal that are not related to the actual input signal being measured. That is, sensor noise may refer to undesirable components that interfere with the accuracy and reliability of sensor readings.

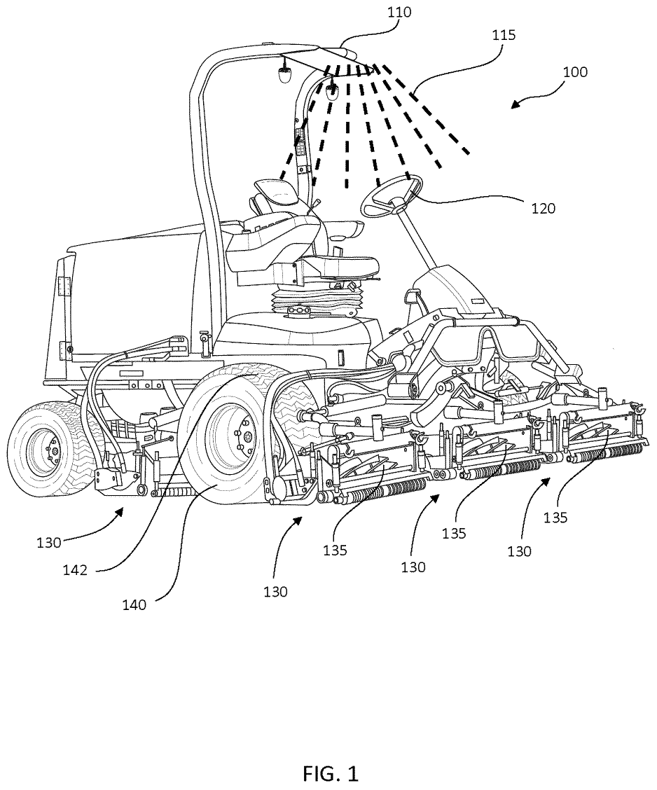

FIG. 1 illustrates an autonomous vehicle 100 comprising an autonomous mower. Although an autonomous mower is used as an example herein, one skilled in the art will understand that the disclosure may be practiced with other types of autonomous vehicles, such as an autonomous car, an autonomous tractor, an autonomous utility vehicle, or other vehicle, as described more fully below. The autonomous vehicle may comprise multiple sub-systems to drive the autonomous vehicle, including a steering control system for autonomously controlling a driving direction of the autonomous vehicle 100 and a speed control system for autonomously controlling a speed of the autonomous vehicle 100 (as discussed more fully below).

The autonomous vehicle may also comprise an implement control system for operating an implement that may be connected to the autonomous vehicle 100. The implement may connect to the autonomous vehicle 100 and may be operated by the autonomous vehicle system to perform a task within the operating environment. An implement may comprise, for example, a mower reel, a mower rotary blade, a shovel, a tractor planter, a tractor seed drill, a tractor rotavator, a tractor spreader, a tractor mower, a tractor harvester, a backhoe, a bale grabber, a forklift, a land leveler attachment, a dump bed, or a boom and bucket.

The autonomous vehicle 100 may also include one or more sensors. Autonomous vehicles may rely on exteroceptive visual sensors for navigation within an operating environment. The visual sensors may send signal data that may be used to represent the operating environment. The visual sensors may include LiDAR sensors (e.g., 2D and/or 3D LiDAR sensors), cameras (e.g., conventional video cameras or infrared cameras), radar, or other sensors for representing the operating environment.

The autonomous vehicle 100 may comprise one or more visual sensors disposed about the exterior of the autonomous vehicle 100. The autonomous vehicle 100 may include more-capable primary visual sensors and less-capable secondary visual sensors. When compared to secondary visual sensors, primary visual sensors may be more capable in that they may have a larger field of view (e.g., wider view, greater viewing angle, wider aperture) or a larger detection range, may collect data in more planes, may collect data at a higher collection density rate, or may otherwise have greater capacity along at least one parameter when compared with the secondary sensor. The primary visual sensor may comprise a 3D LiDAR, 2D LiDAR, a camera, or a radar sensor.

For example, the primary visual sensor may comprise a 3D LiDAR sensor and the secondary visual sensor may comprise a 2D LiDAR sensor. In another example, the primary visual sensor may comprise a 3D LiDAR sensor and the secondary visual sensor may comprise a camera image. In another example, the primary visual sensor may comprise a 2D LiDAR sensor and the secondary visual sensor may comprise a radar sensor.

In other embodiments, the primary visual sensor(s) may be a sensor that is primarily relied upon to navigate the autonomous vehicle 100 during normal operation (e.g., when driving the autonomous vehicle 100 forwards), whereas secondary visual sensors may be generally used during non-normal operation (e.g., when driving the autonomous vehicle 100 in reverse). For example, the autonomous vehicle 100 may include a primary visual sensor 110 which may be located at a relatively frontwards and elevated portion of the autonomous vehicle 100 to prevent parts of the autonomous vehicle 100 from obstructing the view of the primary visual sensor 110 and thereby enable a large sensor FOV 115. The primary visual sensor 110 may be a 3D LiDAR sensor that is used to produce point cloud data representing the operating environment.

The autonomous vehicle 100 may additionally comprise one or more secondary visual sensors. The secondary visual sensors may be positioned such that the secondary visual sensor FOV extends over a portion of the operating environment that is not within the primary visual sensor FOV. For example, the primary visual sensor 110 may be disposed towards a frontward and elevated portion of the autonomous vehicle 100 and the secondary visual sensors may be disposed towards a lowered rear and/or sides of the autonomous vehicle 100. In this arrangement, the primary visual sensor FOV may extend forwards to observe the operating environment in front of the autonomous vehicle 100, such that signal data sent from the primary visual sensor 110 may be primarily relied upon to navigate the autonomous vehicle 100 when driving forwards, whereas the secondary visual sensor FOV may extend, for example, rearwards to observe the operating environment behind the autonomous vehicle 100, such that signal data sent from the secondary visual sensor may be primarily relied upon to navigate the autonomous vehicle 100 when the driving backwards.

In this manner, signal data received from visual sensors may be used to produce representations of the operating environment and identify obstacles therein. However, autonomous vehicle systems may often experience difficulty in determining when signal data may be accurately relied upon. For example, obstacles and environmental conditions (e.g., rain, snow, dust, smoke, etc.) may obscure a sensor field of view within the operating environment.

Importantly, a malfunctioning sensor may also decrease sensor reliability. Internal malfunctions (i.e., malfunctions due to a problem with components within the sensor, as a result of connection to other electrical systems, or due to improper receptions and/or recognition by the other electrical systems) may result in a lack of data sent to and/or received by the autonomous system or may result in excessively noisy, randomized, or garbled data. Typically, such sensors may be identified and the autonomous system may be configured in these instances so that any data from a malfunctioning sensor is not relied upon to navigate the autonomous vehicle.

However, at times visual sensors may send signal data that appears to faithfully represent the operating environment, but which in fact is inaccurate. For example, for reasons not always known to designers of autonomous vehicle systems, visual sensors may malfunction. Visual sensors may provide information that appear to contain an accurate description of the operating environment, but which in reality does not accurately depict the operating environment.

For example, a visual sensor may send the same data continuously despite that the sensor FOV of the visual sensor may have changed (e.g., due to the changing position of the autonomous vehicle and/or the changing position of the visual sensor). For example, the visual sensor may repeatedly send an identical signal. In another example, the visual sensor may repeatedly send an identical sequence of signals, such as the last 10 collected frames repeatedly, or may send the same data collected over a particular time period (e.g., 500 milliseconds) repeatedly. Repeating signal data sent from a malfunctioning visual sensor is often referred to as “stale signal data” because it is outdated and may no longer reflect the current state of the operating environment.

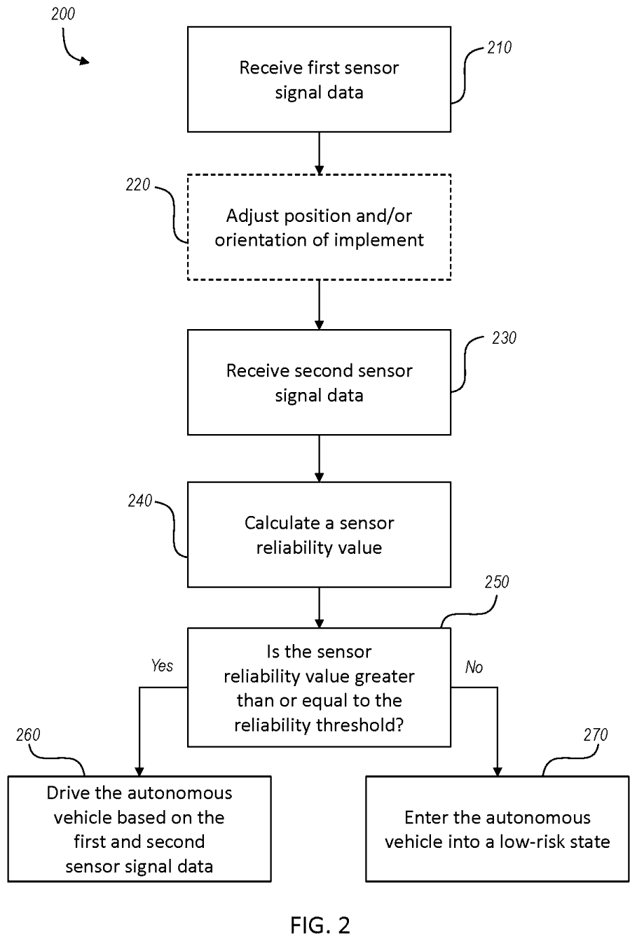

FIG. 2 illustrates a flowchart of process 200 for identifying stale signal data and operating the autonomous vehicle 100 depending on the reliability of the visual sensor signal data (e.g., LiDAR signal data). The process 200 may rely on identifying changes between subsequent sensor signals to determine that the visual sensor is operating correctly.

Identifying noise within the sensor signal data may indicate that the signal data is reliable. For example, two or more frames of signal data observing at least overlapping portions of an operating environment or of the autonomous vehicle 100, but collected at the different times, may be compared. Noise in signal data is a natural phenomenon of a full-functioning visual sensor and signal data representing the overlapping portions may be compared to identify noise within the signal data. If noise is detected, then the visual sensor may be assumed to be functioning correctly. The sensor FOV when collecting the two or more frames may contain a static surface, such as a ground surface of the operating environment or a surface of the autonomous vehicle 100 that does not move relative to the visual sensor, to enable overlapping portions to be detected within the visual sensor signal data.

Regarding process 200 more specifically, in a first step 210, a processor of the autonomous vehicle 100 may receive first sensor signal data (e.g., first LiDAR signal data) from the visual sensor. Then at a time thereafter, at step 230, the processor may receive second sensor signal data (e.g., second LiDAR signal data) from the visual sensor. The sensor FOV when collecting the first sensor signal data and the second sensor signal data may include a static surface, such as a static surface of the operating environment and/or of the autonomous vehicle 100. A sensor reliability value (e.g., comprising a LiDAR reliability value) associated with the visual sensor may then be calculated in step 240. The sensor reliability value may indicate the likelihood the visual sensor is sending signal data that reliably represents the operating environment and/or the autonomous vehicle 100. The sensor reliability value may be based on the first and second sensor signal data. Specifically, the sensor reliability value may be based on identifying differences between first and second sensor signal data and a discussion regarding calculation of the sensor reliability value will be presented more fully below.

In one embodiment, a pulsating light may be shown upon the static surface within the sensor FOV, and which may further aid in identifying differences between the first and second sensor signal data. The pulsating light may be light that may be detected by the visual sensor, such as a LiDAR sensor. For example, the pulsating light may comprise visible light, infrared light, near infrared light (NIR) within a wavelength range of 750 nanometers to 1400 nanometers, or short wavelength infrared (SWIR) within a wavelength range of 1400 nanometers to 3000 nanometers. The light may pulsate, such that the light is shown upon the static surface when one, but not both, of the first and second sensor signal data is collected. For example, at a first time, the pulsating light may be turned off and the visual sensor may collect and send the first sensor signal data. Then, at a second time, the pulsating light may be turned on and the visual sensor may collect and send the second sensor signal data. When the first and second sensor signal data are compared, detection of the differences between the signal data due to the pulsating light may increase or maintain the sensor reliability value.

In step 250, the sensor reliability value may be compared to a reliability threshold. The reliability threshold may be set depending on the task to be completed by the autonomous vehicle 100 and/or the risk operating the autonomous vehicle 100 poses to people, life, and/or property. At step 260 when the sensor reliability value is greater than or equal to the reliability threshold, the visual sensor may be considered sufficiently reliable and signal data (e.g., the first and second sensor signal data) received from the visual sensor may be used to navigate the autonomous vehicle 100 through the operating environment.

Navigating the autonomous vehicle 100 through the operating environment (in process 200 and other processes described herein) may include selecting a path through the operating environment based on the first and second sensor signal data. Additionally, or alternatively, navigating the autonomous vehicle 100 through the operating environment may include, for example, communicating steering commands to the steering control system, or communicating braking commands to the speed control system (e.g., to the braking mechanism of the speed control system), based on the first and/or second sensor signal data.

When the sensor reliability value is less than the reliability threshold the autonomous vehicle 100 may be instructed to enter a low-risk state at step 270. Entering the low-risk state may include one or more of several responses. For example, entering the low-risk state may include (e.g., via the speed control system) slowing a velocity of the autonomous vehicle 100 or stopping the autonomous vehicle 100. Entering the low-risk state may include notifying a remote operator. Notifying a remote operator may include informing the remote operator that the visual sensor is not sufficiently reliable or may include sending a camera image (e.g., of the operating environment) and/or representation of the first and/or second sensor signal data. Entering the low-risk state may include (e.g., via the implement control system) preventing movement of an implement connected to the autonomous vehicle 100 or providing a notification comprising a camera image of the implement to the remote operator.

In some embodiments, the reliability of the visual sensor may be determined based on detection of movement by an implement within the sensor FOV. That is, rather than detecting noise within the first and second sensor signal data collected on a static surface, the visual sensor may be verified by detecting anticipated movement within the sensor FOV. The movement of the implement may be anticipated when the autonomous vehicle system instructs the implement control system to adjust the position and/or orientation of the implement. When the anticipated change of the position and/or the orientation of the implement is detected then the visual sensor may be considered reliable.

FIG. 1 illustrates that the sensor FOV of the primary visual sensor 110 may not only extend in front of the autonomous vehicle 100, but may also extend over implements of the autonomous vehicle 100, such as a steering wheel 120, reel assemblies 135, and/or one or more driving wheels 140. The position and/or orientation of any one of these implements may change as the autonomous vehicle 100 is driven and the change in position and/or orientation may be detected and used to verify the reliability of the visual sensor. However, the implement, as used in process 200, may be any adjustable and/or moving implement within the sensor FOV of the visual sensor.

Sometimes the implement may be too close to the visual sensor to be detected. However, in some embodiments, a shadow of the implement (e.g., a shadow within the point cloud data of LiDAR sensor signal data or a shadow created by visible light and detected within a camera image) may be detected within the sensor signal data to identify an adjustment in the position and/or orientation of the implement. For example, the primary visual sensor 110 may comprise a 3D LiDAR sensor with a sensor FOV extending over the steering wheel 120 of the autonomous vehicle 100. However, the steering wheel 120 may be too close primary visual sensor 110 to be detected, but the shadow of the implement may be detected within the point cloud data produced by the 3D LiDAR sensor.

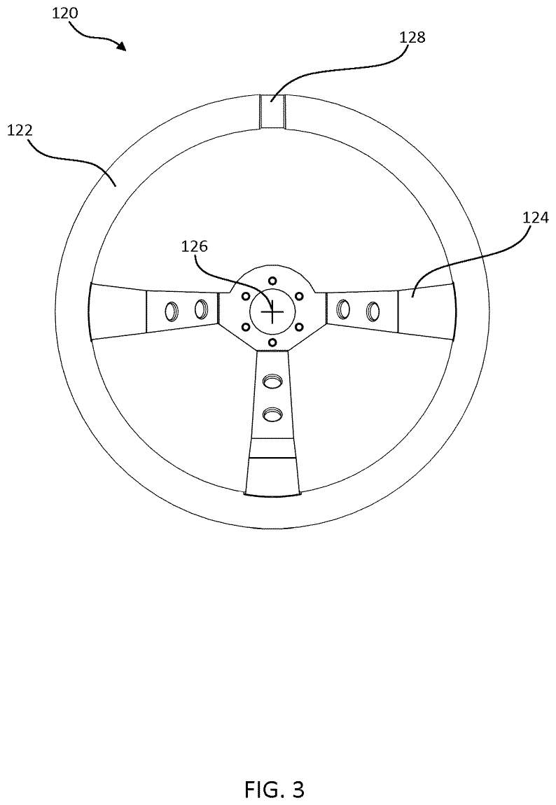

FIG. 3 illustrates a front view of the steering wheel 120. The manner in which the steering wheel is detected may be similar to that of other implements of the autonomous vehicle 100. The autonomous vehicle system may be configured to detect changes in position and/or orientation of the implement, despite that the implement may have a relatively symmetrical profile. For example, autonomous vehicle system may be configured to follow a change in the orientation of the steering wheel 120 as it rotates about a center of rotation 126. Additionally, or alternatively, the autonomous vehicle system may detect non-symmetrical aspects of the implement, such as the spokes 124 or a non-symmetrical indicator 128. In some embodiments, the implement (e.g., steering wheel 120) may be too close to the primary visual sensor 110 (or other sensor) to be detected. The surface of the implement (e.g., the surface 122 of the steering wheel 120) may comprise a reflective surface that may increase the visibility of the implement by the visual sensor. For example, the surface of the implement may comprise reflective materials that reflect visible light well or that reflect infrared light well. The reflective materials may, for example, comprise retroreflective tape.

As illustrated in process 200, the first sensor signal data may be collected at step 210, wherein an implement of the autonomous vehicle 100 is within the sensor FOV and the first sensor signal data indicates a position and/or orientation of implement. Thereafter, at step 220 the implement control system (or the steering control system or speed control system as appropriate) may adjust the position and/or orientation of the implement. For example, the implement control system may adjust a position (e.g., height above a ground surface) of the reel assemblies 130, the steering control system may adjust an orientation of the steering wheel 120, or the speed control system may adjust a rotational speed of the drive wheel 140.

Afterwards, at step 230, the second sensor signal data may be collected by the visual sensor, with the implement within the sensor FOV and wherein the second sensor signal data indicate the position and/or orientation of the implement. The change in the position and/or orientation of the implement between the first and second sensor signal data may then be detected and used to calculate the sensor reliability value. Further, driving the autonomous vehicle may be based on the position and/or orientation of the implement.

For example, the implement may extend from the autonomous vehicle 100 or may be positioned towards an exterior of the autonomous vehicle 100, such that the implement may be likely to contact a surface of the operating environment along one or more paths through the operating environment. The autonomous vehicle 100 may then select a path based on the position and/or orientation of the implement such that the likelihood of contact between the implement and the surface of the operating environment is reduced or prevented. Similarly, the autonomous vehicle 100 may adjust the position and/or orientation of the implement to prevent or reduce the likelihood of contact between the implement and the surface of the operating environment along a selected path, or to increase the available paths through the operating environment wherein the likelihood of contact between the implement and the surface of the operating environment is reduced or prevented.

Step 220 may further include adjusting the position of the implement in and out of the visual sensor FOV. Then in step 240 the sensor reliability value of the visual sensor may then be calculated based on the position of the implement. When the position of the implement and the visual sensor signal data agree the sensor reliability value may be increased (or maintained, for example, at a relatively high value), and when the position of the implement and the visual sensor signal disagree the sensor reliability value may be decreased (or maintained, for example, at a relatively low value). Specifically, when the implement is within a sensor field of view of the LiDAR sensor and the sensor signal data indicates that the implement is within the sensor field of view, the sensor reliability value can be increased. When the implement is within the sensor field of view and the sensor signal data indicates that the implement is not within the sensor field of view, the sensor reliability value can be decreased. When the implement is not within the sensor field of view and the sensor signal data indicates that the implement is within the sensor field of view, the sensor reliability value can be decreased. When the implement is not within the sensor field of view and the sensor signal data indicates that the implement is not within the sensor field of view, the sensor reliability value can be increased.

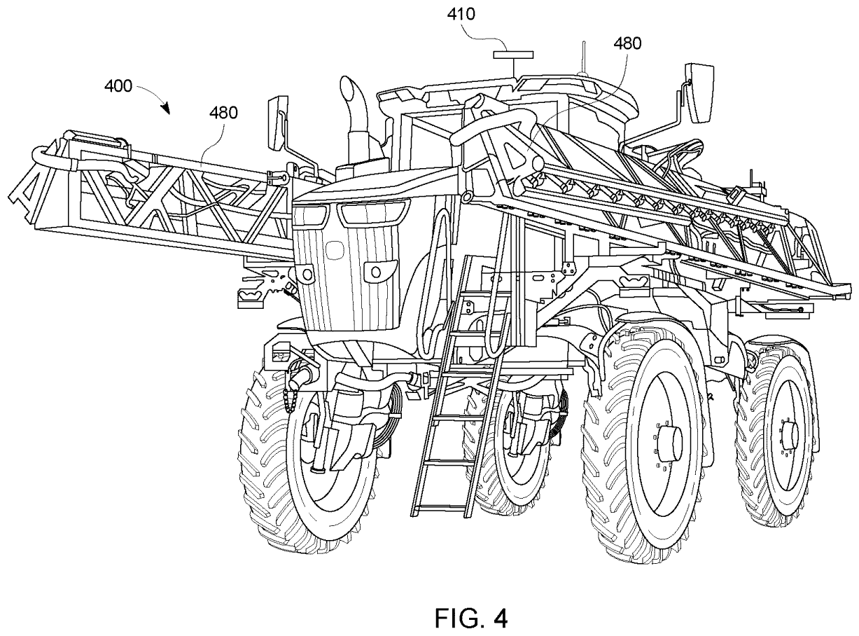

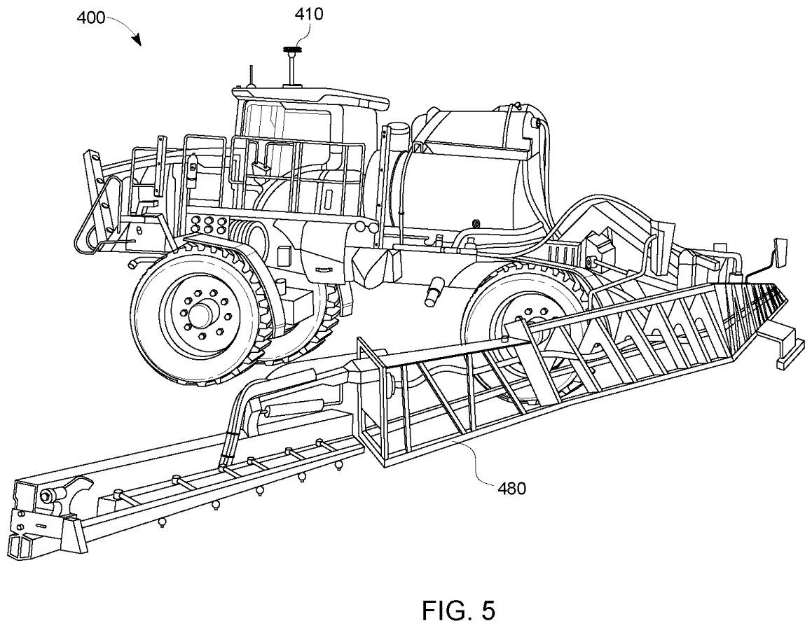

FIGS. 4 and 5 illustrate an autonomous vehicle comprising an autonomous tractor 400 for use in an agricultural environment and which may illustrate execution of the above process 200 in conjunction with an implement. The autonomous tractor 400 may comprise a visual sensor 410 and may connect to an implement comprising a sprayer 480. FIG. 4 illustrates the autonomous tractor 400 with the sprayer 480 in a folded configuration when the sprayer is not in use, while FIG. 5 illustrates the autonomous tractor 400 with the sprayer 480 in an unfolded configuration, for example, when spraying the surface of an operating environment.

Proceeding through process 200, the autonomous tractor 400 may verify the reliability of implement control system to control at least the position of the implement. For example, the autonomous tractor 400 may enter an operating environment with the sprayer 480 in the folded configuration. The autonomous tractor 400 may first receive first sensor signal data from the visual sensor 410, wherein the first sensor signal data indicates that the sprayer 480 is in the folded configuration. Then the autonomous tractor 400 may instruct the implement control system to adjust the position and orientation of the sprayer 480. For example, the autonomous tractor 400 may instruct the implement control system adjust the sprayer 480 to the unfolded configuration, or to a position between the folded and unfolded configurations. The autonomous tractor 400 may then receive second sensor signal data that indicates the position of the sprayer 480.

Thereafter, the sensor reliability value may be calculated based on the first and second sensor signal data. If the first sensor signal data indicates correctly the position of the sprayer 480 in the folded configuration and if the second sensor signal data indicate correctly the position of the sprayer 480 to which it was adjusted (i.e., the unfolded configuration, or the position between the folded and unfolded configurations) then the sensor reliability value may be set to a value higher than the reliability threshold. The autonomous tractor 400 may then be driven based on the first and second signal data.

Alternatively, if the first sensor signal data indicates incorrectly the position of the sprayer 480 in the folded configuration or if the second sensor signal data indicate incorrectly the position of the sprayer 480 to which it was adjusted then the sensor reliability value may be set to a value lower than the reliability threshold. The autonomous tractor 400 may then enter a low-risk state (e.g., preventing driving of the autonomous tractor 400) and the autonomous tractor 400 may be prevented from navigating using the first and second sensor signal data.

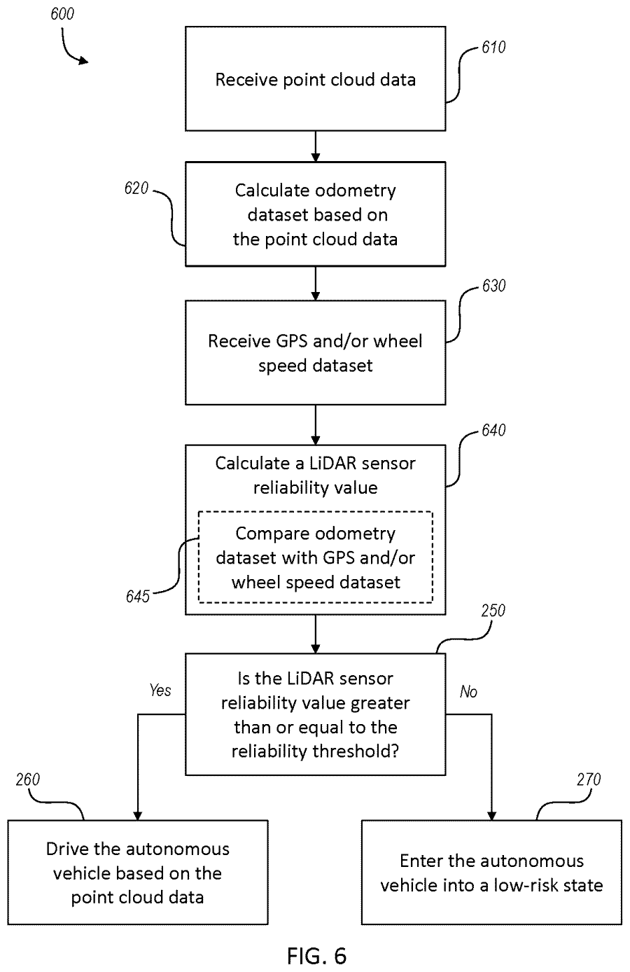

FIG. 6 illustrates another process 600 that may be used to verify the reliability of the visual sensors. Specifically, process 600 verifies the reliability of the visual sensor(s) by comparing odometry data to GPS data and/or to wheel speed data collected by the vehicle.

Process 600 includes a first step 610 wherein the processor receives visual sensor signal data and a second step 620 wherein the visual sensor signal data is used to calculate a first dataset (e.g., an odometry dataset). In some embodiments, the visual sensor is a 3D LiDAR sensor and the visual sensor signal data comprises point cloud data which may be used to calculate the odometry dataset. The odometry dataset may indicate at least one of a velocity of the autonomous vehicle 100, a velocity history of the autonomous vehicle 100 (e.g., comprising a distance driven by the autonomous vehicle 100), a location of the autonomous vehicle 100, a driving time duration of the autonomous vehicle 100, and/or a driving direction of the autonomous vehicle 100.

In step 630, a second dataset may be received comprising data that corresponds to the data of the first dataset. For example, the second dataset may indicate a velocity, velocity history, location, driving time duration, and/or a driving direction of the autonomous vehicle 100 that corresponds with the velocity, velocity history, location, driving time duration, and/or a driving direction of the autonomous vehicle 100 indicated by the first dataset. The second dataset may comprise, as shown, a global positioning system (GPS) dataset or a wheel speed dataset. The second dataset may be received, for example, from an implement of the autonomous vehicle, or may be received from a satellite system.

In step 640, a sensor reliability value associated with the visual sensor, such as a LiDAR sensor reliability value associated with the 3D LiDAR sensor, may be calculated. Calculation of the sensor reliability value (e.g., the LiDAR sensor reliability value) may be performed at sub-step 645 wherein the first dataset (e.g., odometry dataset) is compared with an analogous second dataset (e.g., GPS and/or wheel speed dataset). The sensor reliability value may be set according to the degree to which the odometry dataset confirms, aligns with, or does not deviate from the GPS dataset and/or the wheel speed dataset. For example, the odometry dataset derived from the visual sensor signal data may indicate a series of positions and/or orientations over time. A GPS dataset may also provide a series of positions and/or orientations over time. The sensor reliability value may then be set according to the degree to which the positions and/or orientations of the odometry dataset agree or confirm the positions and/or orientations of the GPS dataset, or if the positions and/or orientations agree within a particular tolerance. Thereafter, the vehicle may proceed through steps 250, 260, and/or 270 to evaluate the sensor reliability value relative to the reliability threshold and drive the autonomous vehicle 100.

A wheel speed may be calculated based on the visual sensor signal data. For example, the wheel speed may be calculated based on odometry dataset. Alternatively, the wheel speed may be based on the first and/or second sensor signal data described in connection with FIG. 2 above. The wheel speed may then be used to navigate the autonomous vehicle 100. For example, instructing the steering control system and the speed control system to drive the autonomous vehicle along a path through the operating environment may be based on the wheel speed calculated using the visual sensor signal data.

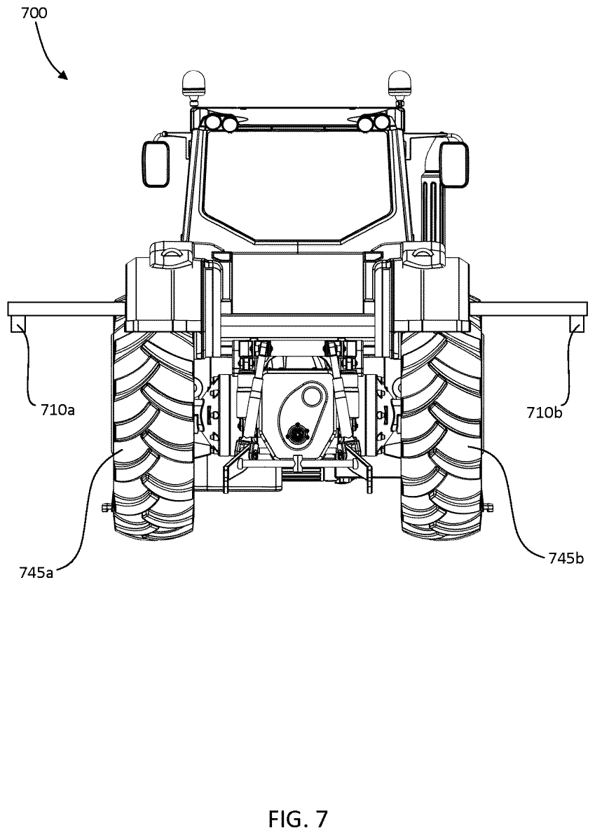

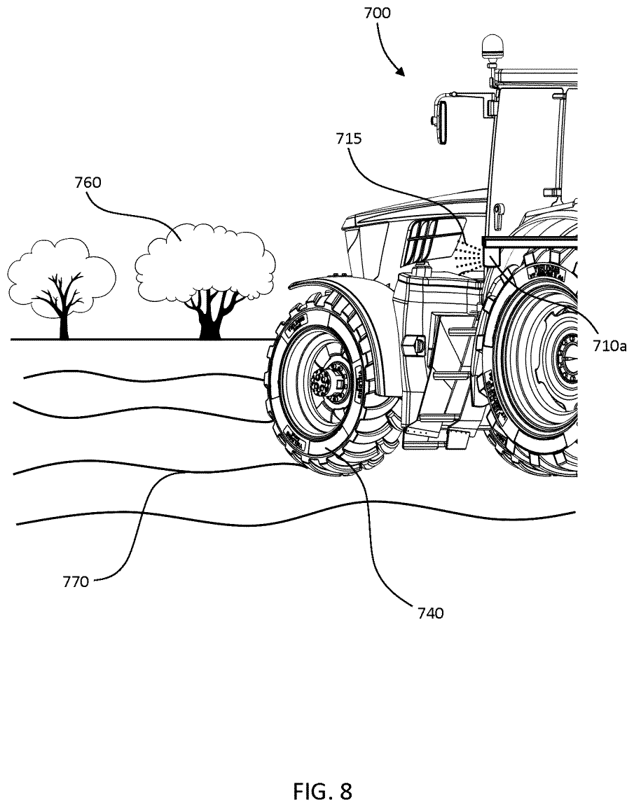

FIGS. 7 and 8 are useful for illustrating how the odometry dataset may be produced and for illustrating execution of process 600. FIGS. 7 and 8 illustrate an autonomous vehicle 700 comprising an autonomous tractor. The autonomous vehicle 700 may comprise one or more 3D LiDAR sensors 710a, 710b that produce signal data for calculating an odometry dataset. That is, the odometry dataset may be based on 3D LiDAR point cloud data.

As the autonomous vehicle 700 drives along a path through the operating environment, the 3D LiDAR sensors 710a, 710b may generate point cloud data for producing an odometry dataset. For example, a transformation algorithm may be performed on the point cloud data, including algorithms such as simultaneous localization and mapping (SLAM), LiDAR odometry and mapping (LOAM), modular open LiDAR odometry and mapping (MOLA-LO) algorithms, or visual-inertial odometry (e.g., for visual sensors comprising a camera) to produce the odometry dataset based on the point cloud data.

For example, the 3D LiDAR sensor FOV 715 may include a ground surface 770 of the operating environment, an obstacle within the environment, or a surface of a drive wheel 740 (e.g., treads 745a, 745b of drive wheel 740 or tread 142 of the drive wheel 140 at FIG. 1), any of which may be observed by the 3D LiDAR sensors 710a, 710b to generate point cloud data useful for forming the odometry dataset. The autonomous vehicle 700 illustrates that the autonomous vehicle 700 may comprise two 3D LiDAR sensors 710a, 710b that may, for example, extend from the sides of the autonomous vehicle 700. This may allow the 3D LiDAR sensors 710a, 710b to detect a ground surface 770 of the operating environment, an obstacle (such as a tree 760) within the operating environment, or the rim the drive wheel 740, the side surface of the drive wheel 740, or the tread 745a, 745b of the drive wheel 740, any of which may be used to generate signals that may be used to produce the odometry dataset.

Calculation of the sensor reliability value may depend on various factors. For example, the sensor reliability value may depend on visual sensor signal data, such as the first and second sensor signal data described above. The visual sensor signal data may indicate a static surface (e.g., of the operating environment or of the autonomous vehicle 100) or may indicate a position and/or orientation of an implement. The sensor reliability value may depend on implement sensor signal data, instructions to the sub-systems of the autonomous vehicle 100, such as the speed control system, the steering control system, and/or the implement control system. The sensor reliability value may depend on a dataset produced from the above signal data, such as an odometry dataset. The sensor reliability value may depend on a dataset associated with the autonomous vehicle 100, such as a GPS dataset or a wheel speed dataset.

The sensor reliability value may extend within a range, and particular sensor reliability values, or ranges of values, may indicate to what extent the visual sensor signal data may be relied upon. For example, the sensor reliability value may be a number that extends between 0 to 100, wherein a value of 0 indicates that the visual sensor signal data is not reliable and wherein a value of 100 indicates that the visual sensor signal data is very likely reliable. Values between 0 and 100 can indicate the relative reliability of the visual sensor, such as not likely reliable, likely reliable, and/or unknown. The reliability threshold may be set to a value within the range of the sensor reliability value, for example, with a larger reliability threshold indicating greater desired reliability of the visual sensor signal data before continuing to rely on the visual sensor signal data to navigate the autonomous vehicle 100.

The sensor reliability value may be calculated based on the degree to which visual sensor signal data, or a dataset depending therefrom, conforms to or verifies other signal data or datasets described above. For example, the sensor reliability value may be set depending on the degree to which the first sensor signal data aligns with the second sensor signal data. If the first sensor signal data is identical to the second sensor signal data, the sensor reliability value may be set to a relatively low value. The sensor reliability value may be set to a relatively high value if the first sensor signal data is very similar, but not identical, to the second sensor signal data (e.g., with the difference between the signal data originating from sensor signal noise). For example, the sensor reliability value may be relatively high if the first and second sensor signal data align within 80%, 85%, 90%, 95%, 96%, 97%, 98%, 99.0%, 99.1%, 99.2%, 99.3%, 99.4%, 99.5%, 99.6%, 99.7%, 99.8%, or 99.9%, or aligns within a range of values having any two of the foregoing as endpoints. The first sensor signal data may be quickly determined to be not identical to the second sensor signal data by comparing a checksum of the first sensor signal data to a checksum of the second sensor signal data, such that each point or pixel of the first sensor signal data need not be checked against a corresponding point or pixel of the second sensor signal data.

In some embodiments, the sensor reliability value may be based on a variability of the distance from the visual sensor to the surface of the operating environment indicated by visual sensor signal data (e.g., whether the visual sensor signal data indicates a non-zero temporal standard deviation). When the distance from the visual sensor to the surface of the operating environment has at least a minimal amount of variation over time, the senor reliability value may be set relatively high, and when the distance from the visual sensor to the surface of the operating environment does not have at least a minimal amount of variation over time, the sensor reliability value may be set relatively low.

The sensor reliability value may be set based on a probabilistic approach. For example, the sensor reliability value may be based on a Bayes Filtering technique, a Markov chain, and/or a Moving-Average technique. In another example, the sensor reliability value may be set to the degree to which the visual sensor signal data confirms the position and/or orientation of the implement based on instructions sent to the implement control system for adjusting the position and/or orientation of the implement, or based on received implement sensor signal data indicating the position and/or orientation of the implement.

Alternatively, or additionally, only corresponding portions of the first and second sensor signal data need be compared to verify that the signal data is not identical. For example, a portion of points within a point cloud of the first sensor signal data may be compared to a corresponding portion of points within a point cloud of the second sensor signal data, or a portion of pixel values within a camera image of the first sensor signal data may be compared to a corresponding portion of pixel values within a camera image of the second sensor signal data. If the both portions of the sensor signal data are not identical then the first and second sensor signal data may be implied to be not identical.

Calculating the sensor reliability value may depend on identifying a repeating pattern of sensor signal frames within the first and/or second sensor signal data. The autonomous vehicle system may compare two sequential frames of data. Additionally, or alternatively, the autonomous vehicle 100 may compare two non-sequential frames of data. For example, the autonomous vehicle 100 may compare two non-sequential frames separated

The autonomous vehicle 100 may compare multiple (including more than two) frames of data within a frame window. The autonomous vehicle 100 may compare 3, 4, 5, 6, 7, 8, 9, 10, or more than 10 frames of data. That is, each of the frames within the frame window may be compared to each of the other frames within the frame window. The data frames may be sequential or may be separated by one or more intermediate frames.

In another embodiment, the autonomous vehicle 100 may compare frames within a time window. For example, the autonomous vehicle 100 may compare each frame received within a previous time window of approximately 100 milliseconds, approximately 200 milliseconds, approximately 300 milliseconds, approximately 400 milliseconds, approximately 500 milliseconds, approximately 600 milliseconds, approximately 700 milliseconds, approximately 800 milliseconds, approximately 900 milliseconds, or 1000 milliseconds, or within the last approximately 1, 2, 3, 4, 5, 6, 7, 8, 9, 10, 15, 30, 45, or 60 seconds, or within a range of time having any two of the foregoing as endpoints. These frames may be compared in a manner similar to that described above in relation to the two sequential frames. In this manner, the autonomous vehicle 100 may identify repeating signals according to a pattern.

Unreliable implement sensors may also present an obstacle to safe operation of the autonomous vehicle 100. The implement sensor may provide sensor signal data that indicates the position and/or orientation of the implement, particularly in relation to the autonomous vehicle 100 and/or the operating environment. As an autonomous vehicle drives along a path through an operating environment the autonomous vehicle may rely on an implement to perform a particular task using the implement sensor signal data sent from the implement sensor. For example, an autonomous mower may rely on an implement comprising a reel assembly 130 to mow a ground surface within an operating environment. In another example, an autonomous tractor may rely on an implement comprising loader arms and a bale spear to move hay bales through an operating environment. In yet another example, an autonomous loader may rely on an implement comprising a boom and bucket to move material through the operating environment.

The implement may be an adjustable implement, such that the position and/or orientation of the implement may be adjusted to perform the task of the autonomous vehicle, and each of the implements in the above examples may comprise an adjustable implement. Implement sensors may be connected to or may observe a surface of the implement to determine the position and/or orientation of the implement relative to the operating environment (including obstacles therein) and/or to an autonomous vehicle, such as the autonomous vehicle to which the implement is attached or to other autonomous vehicles within the operating environment.

Such sensors may aid the autonomous vehicle in interacting with the operating environment. For example, the implement sensors may include a position sensor (e.g., a rotary or linear encoder, potentiometer, or resolver), a proximity sensor (e.g., an inductive, capacitive, ultrasonic, or infrared sensor), an inertial sensor (e.g., an inertial measurement unit (IMU)), a vision-based sensor (e.g., a camera), a force sensor (e.g., a piezoelectric sensor), and/or a torque sensor. For example, a tractor implement may connect to a torque sensor to provide signals that indicate when the tractor implement contacts a surface (e.g., a ground surface). In another example, a reel assembly of an autonomous mower may comprise a proximity sensor that indicates how close a mower reel is to a surface of the operating environment or that indicates a position of the mower reel relative to the proximity sensor and/or to the rest of the autonomous mower.

However, the functionality of implement sensors may degrade over time, or a faulty implement sensor may be installed on the implement. For example, the implement sensor may experience faulty or stale data similar to that described above in relation to visual sensors. One solution to this problem is to verify the accuracy of the implement sensor signal data through comparison to visual sensor signal data produced from observation of the implement. If both the implement sensor signal data and the visual sensor signal data are in agreement regarding the position and/or orientation of the implement, the autonomous vehicle system may assume that with relative confidence that the implement is in the position and/or orientation indicated by the implement sensor. Instances where the both implement sensor and visual sensor produce error-laden or stale data may present risk to accurate identification of implement position and/or orientation, but the accuracy of the visual sensor may be independently verified using the processes (e.g., processes 200, 600) and techniques described above.

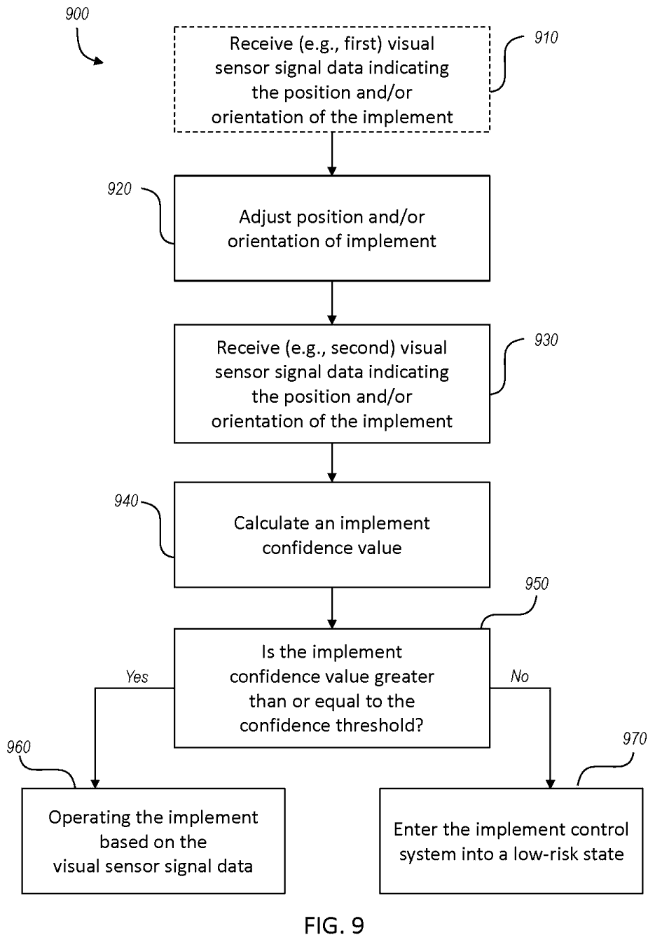

FIG. 9 illustrates a process 900 that may be employed to verify the confidence of the autonomous vehicle that the implement control system may reliably control the position and/or orientation of the implement. The process 900 may include, in a first step 920, instructing an implement control system of the autonomous vehicle to adjust a position and/or orientation of the implement. For example, the implement control system may adjust the position of a bucket of an autonomous loader. In some embodiments, the implement may be controlled by the steering or speed control systems, such that first step 920 may include adjusting an orientation of the drive wheel 140 or the steering wheel 120 by the steering control system.

In a second step 930, the process 900 may include receiving visual sensor signal data (e.g., from a LiDAR sensor), wherein the visual sensor signal data indicates a position and/or orientation of the implement. An implement confidence value associated with the implement can then be calculated based on an expected position and/or orientation of the implement and the visual sensor signal data. The implement confidence value may represent a reliability of the implement control system to operate the implement. The expected position and/or orientation of the implement may be based on the instructions sent to implement control system (and/or steering or speed control systems). For example, if a processor of the autonomous vehicle sent instructions to a loader to lift an implement comprising a bucket to an elevated position, the expected position of the bucket may be the elevated position of the bucket. The implement confidence value may then be based on the degree to which the visual sensor signal data indicates that the bucket is at the elevated position.

Similar to that described above regarding processes 200 and 600, the visual sensor signal data may indicate the position and/or orientation of the implement based on a shadow of the implement. For example, the visual sensor signal data may indicate the position and/or orientation of the implement based on a shadow within the point cloud data of LiDAR sensor signal data or a shadow created by visible light and detected within a camera image.

In some embodiments, calculation of the implement confidence value may be based on comparison between two or more sets of visual sensor signal data. Specifically, the process 900 may include receiving visual sensor signal data at step 910 before the adjusting the position and/or orientation of the implement at step 920. For example, the process 900 may include, at a first time, receiving first visual sensor signal data from the visual sensor, wherein the first visual sensor signal data indicates the implement is in a first position. Then, the autonomous vehicle may proceed through process 900, instructing the implement control system to adjust the position of the implement from the first position to a second position at step 920 and, at a second time, receiving second visual sensor signal data from the visual sensor, wherein the second visual sensor signal data indicates that the implement is in the second position. The implement confidence value may then be calculated at step 940, such that the implement confidence value may be based on the expected position of the implement, the first sensor signal data, and the second sensor signal data.

In some embodiments, the process 900 may comprise instructing the implement control system to adjust the position of the implement in and out of a sensor field of view of the LiDAR sensor. The process 900 may then comprise adjusting the implement confidence value of the implement based on the position of the implement within and/or without the visual sensor FOV and whether the visual sensor signal data confirms the position of the implement. Specifically, the implement confidence value may be adjusted such that, when the implement is within the sensor field of view of the LiDAR sensor and the visual sensor signal data indicates that the implement is within the sensor field of view, the implement confidence value may be increased, and, when the implement is within the sensor field of view and the visual sensor signal data indicates that the implement is not within the sensor field of view, the implement confidence value may be decreased. Further, when the implement is not within the sensor field of view and the sensor signal data indicates that the implement is within the sensor field of view, the implement confidence value may be decreased, and, when the implement is not within the sensor field of view and the sensor signal data indicates that the implement is not within the sensor field of view, the implement confidence value may be increased.

At step 950, the process 900 may compare the implement confidence value to a confidence threshold. When the implement confidence value is greater than or equal to a confidence threshold, the implement control system can operate the implement within the operating environment based on the visual sensor signal data at step 960. When the implement confidence value is not greater than or equal to the confidence threshold the implement control system may enter a low-risk state at step 970.

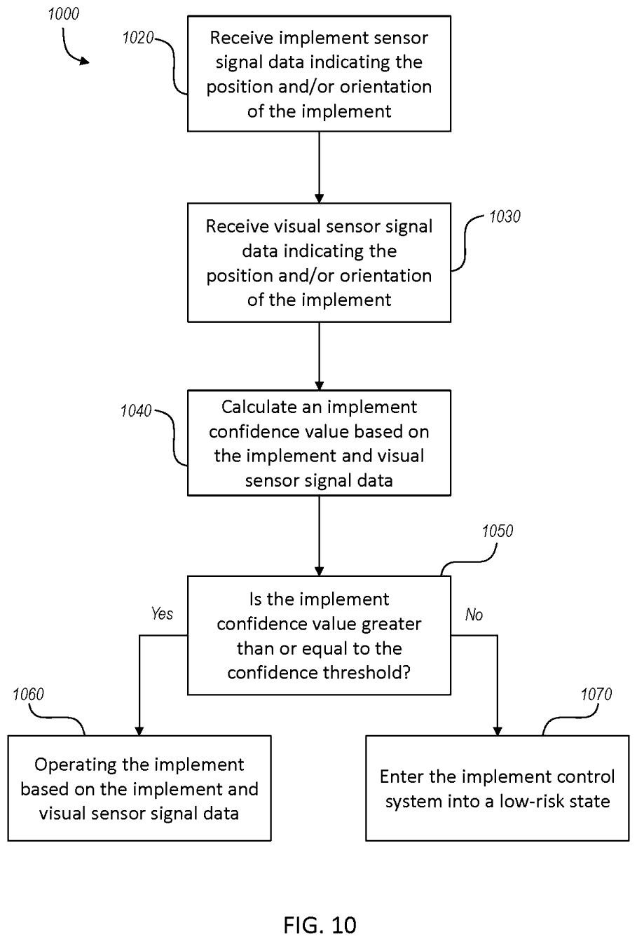

FIG. 10 illustrates another process 1000 that may be used to verify the reliability of the implement control system over the implement. Reliability of the implement control system may be verified by comparing visual sensor signal data to corresponding implement sensor signal data and adjusting the implement confidence value according to the alignment or agreement between the visual and implement sensor signal data.

The process 1000 may comprise a first step 1020 that includes receiving implement sensor signal data from an implement sensor. The implement sensor signal may indicate a position and/or orientation of the implement. The process 1000 may also comprise a second step 1030 that includes receiving visual sensor signal data that indicates a position and/or orientation of the implement, such that the implement is within the visual sensor FOV of the visual sensor. The visual sensor signal data may correspond (e.g., in time, portion of the implement, etc.) to the implement sensor signal data. For example, the visual sensor signal data may be collected at a same or similar time as collection of the implement sensor signal data implement sensor signal data, such as within a time period of approximately 100, 200, 300, 400, 500, or 1000 milliseconds, or within a range of time having any two of the foregoing as endpoints.

The visual sensor signal data may correspond to the implement sensor signal data, in that the visual and implement sensor signal data may indicate information about the same implement or about the same portion of the implement. In some embodiments, the visual sensor signal data may be received from a visual sensor attached to another device or another autonomous vehicle. For example, the visual sensor signal data may indicate the position and/or orientation of an implement attached to another autonomous vehicle, such that operation of an implement attached to a first autonomous vehicle may be observed by a visual sensor of a second autonomous vehicle. Such cooperation between autonomous vehicles may improve efficient and safe operation of an implement within an operating environment.

Then, similar to process 900, the process 1000 may proceed to step 1040 to calculate an implement confidence value associated with the implement. The implement confidence value may be based on the implement sensor signal data and the visual sensor signal data. The implement confidence value may then be compared to the confidence threshold in step 1050. At step 1060, when the implement confidence value is greater than or equal to a confidence threshold, the implement control system may be instructed to operate the implement within an operating environment based on the implement sensor signal data and/or the visual sensor signal data. At step 1070, when the implement confidence value is less than the confidence threshold, the implement control system may be instructed to enter a low-risk state.

Calculating the implement confidence value may be similar to calculation of the sensor reliability value described above. In some embodiments, the instructions sent to the implement control system may be used to set an expected position of the implement. For example, the instructions may be used to produce an image of the implement within a representation of the operating environment. The implement confidence value may then be calculated based on the degree to which the visual sensor signal data illustrates or confirms the implement is in the correct position (e.g., the degree to which the visual sensor signal data reproduces the image of the implement within the operating environment). In other words, calculation of the implement confidence value may be based on determining if the implement state determined by processing the implement sensor signal data matches the implement state as determined by processing the visual sensor signal data (e.g., LiDAR signal data). For example, the implement confidence value may be set based on the degree to which the visual sensor signal data indicates the orientation of the steering wheel 120 confirms a driving angle indicated by a steering angle sensor.

In some embodiments, the autonomous vehicle may rely on visual sensor signal data to the exclusion of implement sensor signal data. For example, the autonomous vehicle may elect to rely on visual sensor signal data instead of implement sensor signal data (even if the implement sensor signal data conflicts significantly with the visual sensor signal data). In another example, the autonomous vehicle may rely on visual sensor signal data when no corresponding implement sensor signal data is available (e.g., when the implement sensor signal malfunctions and does not send any signal data, or when no implement configured to send implement sensor signal data that corresponds to visual sensor signal data is connected to the autonomous vehicle and/or the implement).

Entering the implement control system into the low-risk state may be similar to entering the autonomous vehicle into the low-risk state described above. Entering the implement control system into the low-risk state may comprise slowing a movement of the implement, preventing a movement of the implement, preventing the implement control system from operating the implement, or returning the implement to a closed or home position (e.g., the folded state of the sprayer 480 of autonomous tractor 400 described above). The closed or home position may be a position of the implement in which the implement is positioned when stored or typically inactive. Entering the implement control system into the low-risk state may additionally, or alternatively, comprise notifying a remote operator, such as sending the remote operator a camera image of the implement, or sensor signal data observing the implement, such as information based on visual sensor signal data or implement sensor signal data.

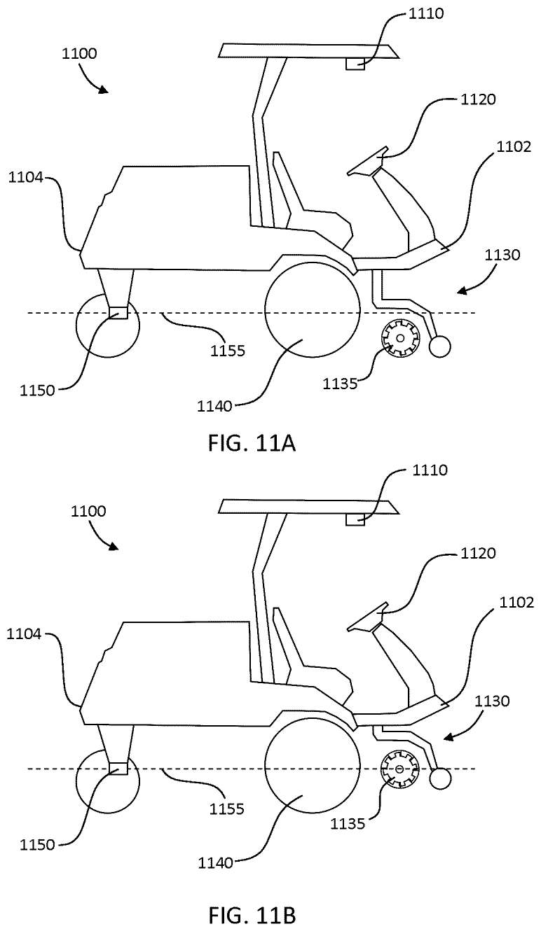

FIG. 11A-11B show a simplified cross-section of an autonomous mower 1100 similar to the autonomous vehicle 100 shown in FIG. 1, which may be useful in illustrating the execution of processes 900 and 1000 to verify the reliability of an implement control system comprising a reel control system and/or to verify the position of an implement. Similar to the autonomous vehicle 100, the autonomous mower 1100 may comprise several implements, including a steering wheel, a reel assembly 1130 including a mower reel 1135 (configured to receive instructions from the reel control system), and a drive wheel 1140. The reel control system of the autonomous mower 1100 may be configured to adjust a height of the reel assembly 1130 (and thus the mower reel 1135) above a ground surface of the operating environment. For example, the reel control system may adjust a position of the reel assembly to one or more elevated positions and/or one or more lowered positions. The autonomous mower 1100 may also comprise a primary visual sensor 1110 and a secondary visual sensor 1150.

In this example, the primary visual sensor 1110 is positioned towards a front 1102 of the autonomous mower 1100 and may comprise a 3D LiDAR sensor having a primary sensor FOV that extends in multiple planes, for example, in front of and to the side of the autonomous mower 1100 and over the steering wheel 1120, drive wheel 1140, and the reel assembly 1130. In this example, the secondary visual sensor 1150 may comprise a 2D LiDAR sensor, such that the secondary sensor FOV 1155 extends along a single plane behind and/or along a bottom surface of the autonomous mower 1100. However, in alternative embodiments, the second visual sensor 1150 may similarly comprise a 3D LiDAR sensor, such that the secondary sensor FOV 1155 extends along a multiple planes behind and/or along a bottom surface of the autonomous mower 1100 to detect the exact position of obstacles and/or the mower reel. The secondary visual sensor 1150 may be positioned towards a rear 1104 of the autonomous mower 1100 to observe the operating environment behind the autonomous mower 1100 for detecting obstacles when, for example, the mower 1100 autonomously drives in reverse. However, the secondary visual sensor 1150 may be additionally, or alternatively, used to verify the position and/or orientation of the mower reel 1135.

The autonomous mower 1100 may instruct the reel control system to raise or lower the reel assembly 1130 at different locations within the operating environment, according to the desire of the remote operator and/or the requirements of the task. For example, reel control system may lower the reel assembly 1130 to a lowered position, shown in FIG. 11A, to cut the surface of the operating environment closely. Conversely, the reel control system may raise the reel assembly 1130 to an elevated position, shown in FIG. 11B, so as to raise the reel assembly 1130 above obstacles or cut the surface of the operating environment at a greater height.

The height of the reel assembly 1130 above a ground surface of the operating environment may be detected by the secondary visual sensor 1150. For example, the distance between the secondary visual sensor 1150 and the reel assembly 1130 may vary along the height of the reel assembly 1130, such that the height of the reel assembly 1130 may be determined by detecting the distance between the secondary visual sensor 1150 and the reel assembly 1130. The visual sensor signal data sent by the secondary visual sensor 1150 may then be used to verify the instructions sent to the implement control system and/or may verify the implement sensor signal data.

The autonomous mower 1100 may then execute process 900 (e.g., to verify a position of the mower reel 1135 and/or to confirm control of the implement control system) to operate the mower reel assembly 1130. Specifically, first sensor signal data may be received in predetermined time packets from the secondary visual sensor 1150 (e.g., a 2D LiDAR sensor), wherein the first sensor signal data indicates the reel is in a first position of an elevated position and a lowered position (see step 910). The reel control system may be instructed to adjust a position of the mower reel 1135 (see step 920). For example, the reel control system may adjust the position of the mower reel 1135 from the elevated position (see FIG. 11B) to a lowered position (see FIG. 11A), for example, preparatory to mowing the surface of the operating environment. Second sensor signal data may then be received in predetermined time packets from the secondary visual sensor 1150 (e.g., a 2D LiDAR sensor), wherein the visual sensor signal data indicates the position of the mower reel 1135 (see step 930). For example, the visual sensor signal data may indicate that the mower reel 1135 is in the lowered position or may indicate that the mower reel 1135 is not in the lowered position.

An implement confidence value associated with the mower reel 1135, representing the reliability of the reel control system when operating the mower reel 1135) may then be calculated based on an expected position of the mower reel 1135 and the first and/or second sensor signal data (see step 940). When the implement confidence value is greater than or equal to a confidence threshold, the reel control system may be instructed to operate the mower reel 1135 with an operating environment based on the visual sensor signal data. When the implement confidence value is less than the confidence threshold, instruct the reel control system to enter the low-risk state (see step 950).

For example, the visual sensor signal data may indicate that the mower reel 1135 is in the lowered position, the implement confidence value may be set higher than the confidence threshold. The mower reel 1135 may then be operated based on the visual sensor signal data, such that the implement is operated with confidence that the mower reel 1135 is in the correct position when mowing (see step 960).

In another example, the visual sensor signal data may indicate that the mower reel 1135 is not in the lowered position. Then the implement confidence value may be set to a value lower than the confidence threshold. The reel control system may then be entered into a low-risk state (see step 970). For example, the reel control system may prevent operation of the mower reel (e.g., preventing the mower reel from rotating to cut a surface of the operating environment).

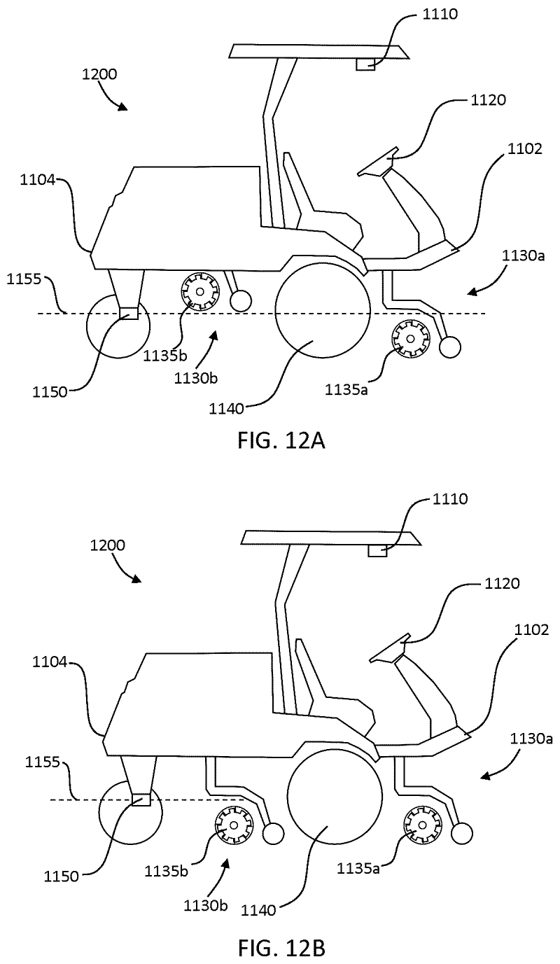

FIGS. 12A-12B illustrate that an autonomous mower 1200 that may comprise multiple reel assemblies 1130, including one or more front reel assemblies, such as front reel assembly 1130a, disposed in front of the drive wheel 1140 and one or more intermediate reel assemblies, such as intermediate reel assembly 1130b, disposed between the drive wheel 1140 and a rear wheel of the autonomous mower 1100.

Signal data from the secondary visual sensor 1150 may be used to verify the position of both the front and the intermediate reel assemblies 1130a, 1130b. For example, the intermediate reel assembly 1130b may be raised to an elevated position so as not to obstruct the secondary sensor FOV 1155 while the secondary visual sensor 1150 verifies the position of the front reel assembly 1135a (see FIG. 12A). Then, once the position of the front reel assembly 1135a has been verified, the intermediate reel assembly 1135b may be lowered to the desired position which may be verified by the secondary visual sensor 1150.

Similarly, a first implement of an autonomous vehicle located closer to a visual sensor may be moved or prevented from obstructing observation of a second implement by the visual sensor to enable the visual sensor signal data to indicate the position of the second implement.

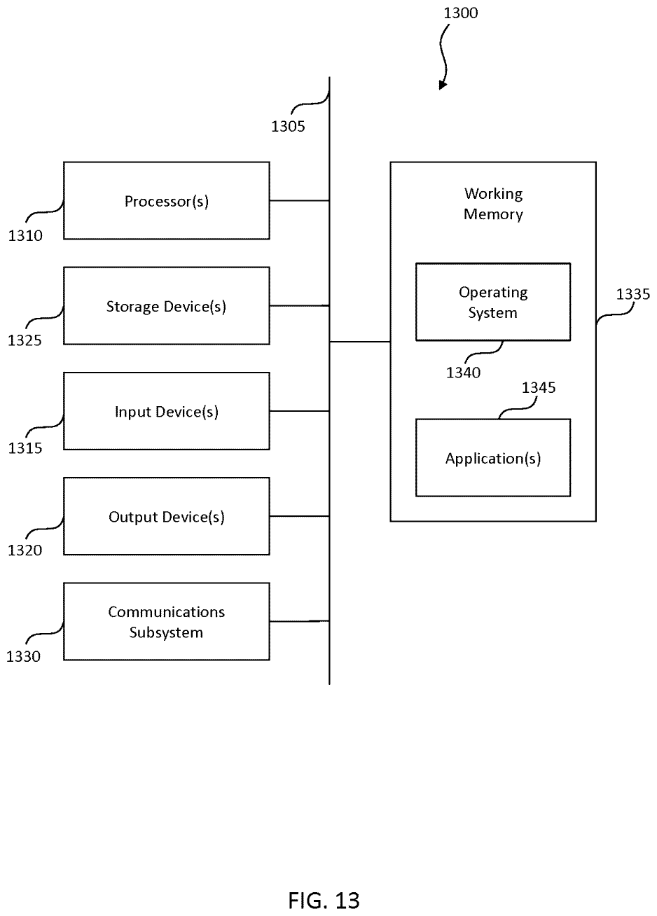

The computational system 1300, shown in FIG. 13, can be used to perform any of the embodiments of the invention. For example, computational system 1300 can be used to execute processes 200, 600, 900, and/or 1000. As another example, computational system 1300 can be used to perform any calculation, identification, and/or determination described here. Computational system 1300 includes hardware elements that can be electrically coupled via a bus 1305 (or may otherwise be in communication, as appropriate). The hardware elements can include one or more processors 1310, including without limitation one or more general-purpose processors and/or one or more special-purpose processors (such as digital signal processing chips, graphics acceleration chips, and/or the like); one or more input devices 1315, which can include without limitation a mouse, a keyboard, and/or the like; and one or more output devices 1320, which can include without limitation a display device, a printer, and/or the like.

The computational system 1300 may further include (and/or be in communication with) one or more storage devices 1325, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 1300 might also include a communications subsystem 1330, which can include without limitation a modem, a network card (wireless or wired), an infrared communication device, a wireless communication device and/or chipset (such as a Bluetooth device, an 502.6 device, a Wi-Fi device, a WiMax device, cellular communication facilities, etc.), and/or the like. The communications subsystem 1330 may permit data to be exchanged with a network (such as the network described below, to name one example), and/or any other devices described herein. In many embodiments, the computational system 1300 will further include a working memory 1335, which can include a RAM or ROM device, as described above.

The computational system 1300 also can include software elements, shown as being currently located within the working memory 1335, including an operating system 1340 and/or other code, such as one or more application programs 1345, which may include computer programs of the invention, and/or may be designed to implement processes of the invention and/or configure systems of the invention, as described herein. For example, one or more procedures described with respect to the process(s) discussed above might be implemented as code and/or instructions executable by a computer (and/or a processor within a computer). A set of these instructions and/or codes might be stored on a computer-readable storage medium, such as the storage device(s) 1325 described above.

In some cases, the storage medium might be incorporated within the computational system 1300 or in communication with the computational system 1300. In other embodiments, the storage medium might be separate from a computational system 1300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1300 and/or might take the form of source and/or installable code, which, upon compilation and/or installation on the computational system 1300 (e.g., using any of a variety of generally available compilers, installation programs, compression/decompression utilities, etc.) then takes the form of executable code.

The computational system 1300 may be configured to operate an autonomous vehicle platform. The term “autonomous vehicle”, and related terms (e.g., “autonomous vehicle platform”), as used herein may include manned vehicles, remote control vehicles, and/or manual vehicles, etc. The autonomous vehicle platform may comprise a steering mechanism in communication with the processor, where the processor communicates steering commands to the steering mechanism based on the sensor reliability value and/or the implement confidence value. The autonomous vehicle platform may comprise a braking mechanism in communication with the processor, where the processor communicates braking commands to the braking mechanism based on the sensor reliability value and/or the implement confidence value.

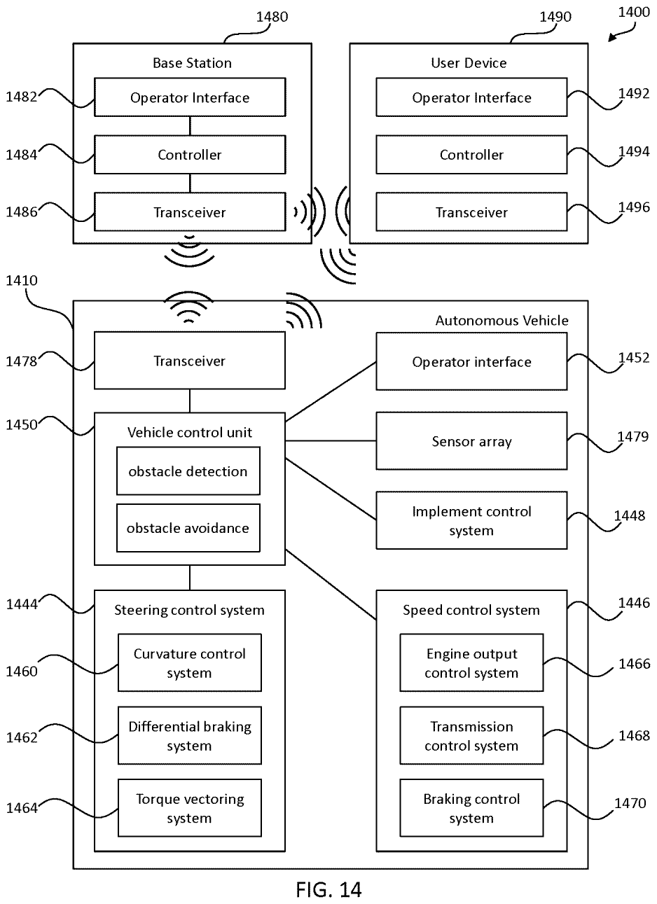

FIG. 14 is a block diagram of a communication and control system 1400 that may be utilized in conjunction with the systems and processes of the disclosure. The communication and control system 1400 may include a vehicle control unit 1450 which may be mounted on an autonomous vehicle 1410. The autonomous vehicle 1410, for example, may include a yard truck, loader, wheel loader, track loader, dump truck, digger, backhoe, forklift, mower (e.g., lawn, field, or brush mower), or other vehicle. The communication and control system 1400, for example, may include any or all components of computational system 1300 shown in FIG. 13.

For example, the autonomous vehicle 1410 may include a steering control system 1444 that may control a direction of movement of the autonomous vehicle 1410. The steering control system 1444, for example, may include any or all components of computational system 1300 shown in FIG. 13.

The autonomous vehicle 1410, for example, may include a speed control system 1446 that controls the speed, acceleration, and deceleration of the autonomous vehicle 1410. The speed control system 1446, for example, may control the speed of the autonomous vehicle 1410 based on map data, control algorithms, obstacle detection, start and/or stop points, input from the operator (e.g., a remote operator), etc. The speed control system 1446, for example, may include any or all components of computational system 1300 shown in FIG. 13.

The autonomous vehicle 1410, for example, may include an implement control system 1448 that may control operation of an implement towed by the autonomous vehicle 1410, integrated within the autonomous vehicle 1410, or coupled to the autonomous vehicle 1410. The implement control system 1448, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 1448, for example, may include any or all components of computational system 1300 shown in FIG. 13.

The vehicle control unit 1450 may be communicatively coupled with the steering control system 1444, the speed control system 1446, and/or the implement control system 1448. The vehicle control unit 1450, for example, may include any or all of the components shown in FIG. 13. The vehicle control unit 1450, for example, may be integrated into a single controller or may include a plurality of distinct components or controllers. The vehicle control unit 1450 may also be coupled with one or more sensors from the sensor array 1479 and receive sensor signal data from the sensor array 1479.

The vehicle control unit 1450, for example, may be used to control various aspects of the vehicle 1410 such as, for example, sending instructions to the steering control system 1444, implement control system 1448, speed control system 1446, etc. The vehicle control unit 1450, for example, may include a vehicle artificial intelligence (VAI) that may include one or more processors that execute one or more algorithms, including processes 200, 600, 900, and/or 1000 disclosed above.

The vehicle control unit 1450, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 1479 or from a base station 1480 (described below).

The vehicle control unit 1450, for example, may be an electronic controller with electrical circuitry configured to process data from the various components of the autonomous vehicle 1410. The vehicle control unit 1450 may include a processor, such as the processor 1310, and a working memory 1335. The vehicle control unit 1450 may also include one or more storage devices, storage media, and/or other suitable components of computational system 1300. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 1450, for example, may include any or all the components shown in FIG. 13.

The vehicle control unit 1450, for example, may include a volatile memory, such as random access memory (RAM), and/or a nonvolatile memory, such as ROM (e.g., working memory 1335, storage device 1325, and/or other computer-readable media). The memory may store a variety of information and may be used for various purposes. For example, the memory may store processor-executable instructions (e.g., firmware or software) for the vehicle control unit 1450 to execute, such as instructions for calculating a drivable path plan, and/or controlling the autonomous vehicle 1410 (e.g., for implementing processes 200, 600, 900, and/or 1000 above). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 1444, for example, may include a curvature rate control system 1460, a differential braking system 1462, a steering mechanism, and a torque vectoring system 1464 that may be used to steer the autonomous vehicle 1410. The curvature rate control system 1460, for example, may control a direction of an autonomous vehicle 1410 by controlling a steering control system of the autonomous vehicle 1410 with a curvature rate, such as an Ackerman style autonomous vehicle, 1410 or articulating vehicle. The curvature rate control system 1460, for example, may automatically rotate one or more wheels or tracks of the autonomous vehicle 1410 via hydraulic or electric actuators to steer the autonomous vehicle 1410. By way of example, the curvature rate control system 1460 may rotate front wheels/tracks, rear wheels/tracks, and/or intermediate wheels/tracks of the autonomous vehicle 1410 or articulate the frame of the vehicle, either individually or in groups. The differential braking system 1462 may independently vary the braking force on each lateral side of the autonomous vehicle 1410 to direct the autonomous vehicle 1410. Similarly, the torque vectoring system 1464 may differentially apply torque from the engine to the wheels and/or tracks on each lateral side of the autonomous vehicle 1410. While the illustrated steering control system 1444 includes the curvature rate control system 1460, the differential braking system 1462, and the torque vectoring system 1464, the steering control system 1444 may include one or more of these systems. Further examples may include a steering control system 1444 having other and/or additional systems to facilitate turning the autonomous vehicle 1410 such as an articulated steering control system, a differential drive system, and the like.

The speed control system 1446, for example, may include an engine output control system 1466, a transmission control system 1468, and a braking control system 1470. The engine output control system 1466 may vary the output of the engine to control the speed of the autonomous vehicle 1410. For example, the engine output control system 1466 may vary a throttle setting of the engine, a fuel/air mixture of the engine, a timing of the engine, and/or other suitable engine parameters to control engine output. In addition, the transmission control system 1468 may adjust gear selection within a transmission to control the speed of the autonomous vehicle 1410. Furthermore, the braking control system 1470 may adjust the braking force to control the speed of the autonomous vehicle 1410. While the illustrated speed control system 1446 includes the engine output control system 1466, the transmission control system 1468, and the braking control system 1470, the speed control system 1446 may include one or two of these systems. The speed control system 1446, for example, may also include other systems and/or additional systems that may be used to control the speed of the autonomous vehicle 1410.

The implement control system 1448, for example, may control various parameters of the implement towed by and/or integrated within the autonomous vehicle 1410. For example, the implement control system 1448 may instruct an implement controller via a communication link, such as a CAN bus, ISOBUS, Ethernet, wireless communications, and/or Broad R Reach type Automotive Ethernet, etc.

The implement control system 1448, for example, may instruct an implement controller to adjust a penetration depth of at least one ground engaging tool of an agricultural implement, which may reduce the draft load on the autonomous vehicle 1410.

The implement control system 1448, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 1448, as another example, may instruct the implement controller to adjust a shovel height, a shovel angle, a shovel position, etc.

The communication and control system 1400, for example, may include a sensor array 1479. The sensor array 1479, for example, may facilitate determination of condition(s) of the autonomous vehicle 1410 and/or the work area. For example, the sensor array 1479 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous vehicle 1410. The sensors may also monitor operating levels (e.g., temperature, fuel level, etc.) of the autonomous vehicle 1410. Furthermore, the sensors may monitor conditions in and around the work area, such as temperature, weather, wind speed, compass, humidity, and other conditions. The sensors of the sensor array 1479, for example, may detect physical objects in the work area, such as a parking stall, a material stall, accessories, other vehicles, obstacles, environmental features, or other object(s) that may be in the area surrounding the autonomous vehicle 1410.

The sensor array 1479, for example, may include a velocity sensor which may include one or more of an inertial measurement unit, a compass, a GPS sensor, a wheel encoder, a tachometer, a camera, a radar, etc. The sensor array 1479, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous vehicle 1410 may include an operator interface 1452 for controlling the vehicle. The operator interface 1452, for example, may be communicatively coupled to the vehicle control unit 1450 and configured to present data from the autonomous vehicle 1410 via a display. Display data may include data associated with operation of the autonomous vehicle 1410, data associated with operation of an implement, a position of the autonomous vehicle 1410, a speed of the autonomous vehicle 1410, a desired path, a drivable path plan, a target position, and/or a current position, etc. The operator interface 1452 may enable an operator to control certain functions of the autonomous vehicle 1410 such as starting and stopping the autonomous vehicle 1410, inputting a desired path, etc. The operator interface 1452, for example, may enable the operator to input parameters that cause the vehicle control unit 1450 to adjust the drivable path plan. For example, the operator may provide an input requesting that the desired path be acquired as quickly as possible, that an off-path normal error be minimized, that a speed of the autonomous vehicle 1410 remain within certain limits, and/or that a lateral acceleration experienced by the autonomous vehicle 1410 remain within certain limits, etc. In addition, the operator interface 1452 (e.g., via the display, or via an audio system (not shown), etc.) may alert an operator if the desired path cannot be achieved, for example.

The communication and control system 1400, for example, may include a base station 1480 having a base station controller 1484 located remotely from the autonomous vehicle 1410. For example, the control functions of the vehicle control unit 1450 may be distributed between the vehicle control unit 1450 of the autonomous vehicle 1410 and the base station controller 1484. The base station controller 1484, for example, may perform a substantial portion of the control functions of the vehicle control unit 1450. For example, a first transceiver 1478 positioned on the autonomous vehicle 1410 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 1486 at the base station 1480. The base station controller 1484, for example, may calculate drivable path plans and/or output control signals to control the curvature control system 1460, the speed control system 1446, and/or the implement control system 1448 to direct the autonomous vehicle 1410 toward the desired path, for example. The base station controller 1484 may include a processor and memory device having similar features and/or capabilities as the processor and the memory device discussed previously. Likewise, the base station 1480 may include an operator interface 1482 having a display, which may have similar features and/or capabilities as the operator interface 1452 and the display discussed previously.

In some embodiments, one or both of the base station 1480 and/or the autonomous vehicle 1410 may be in communication with a user device 1490. A user device 1490 may include a phone, tablet, laptop, or computer. The user device 1490 may similarly include an operator interface 1492 which may include similar features and capabilities as operator interfaces 1452, 1482 described above. Additionally, or alternatively, the user device 1490 may comprise a controller 1494 that may include the same or similar features, components, and/or characteristics as the controller 1484 of the base station 1480. For example, the user device controller 1484 may calculate drivable path plans, output control signals to control the curvature control system 1460, the speed control system 1446, and/or the implement control system 1448 to direct the autonomous vehicle 1410. The user device 1490, for example, can include an application that allows the user (e.g., a remote operator) to communicate commands to the autonomous vehicle 1410 (e.g., via a transceiver 1496) and/or receive information about the autonomous vehicle 1410. Alternatively, or additionally, the user device 1490, for example, can include an application that allows the operator to observe the autonomous vehicle 1410 move through a map of the work area where the autonomous vehicle operates.

The user device 1490, for example, may include an application that can receive an indication associated with the remote operator or which can receive other user or operator inputs. The user device 1490, for example, may include an application that can display any of the information disclosed in this document.

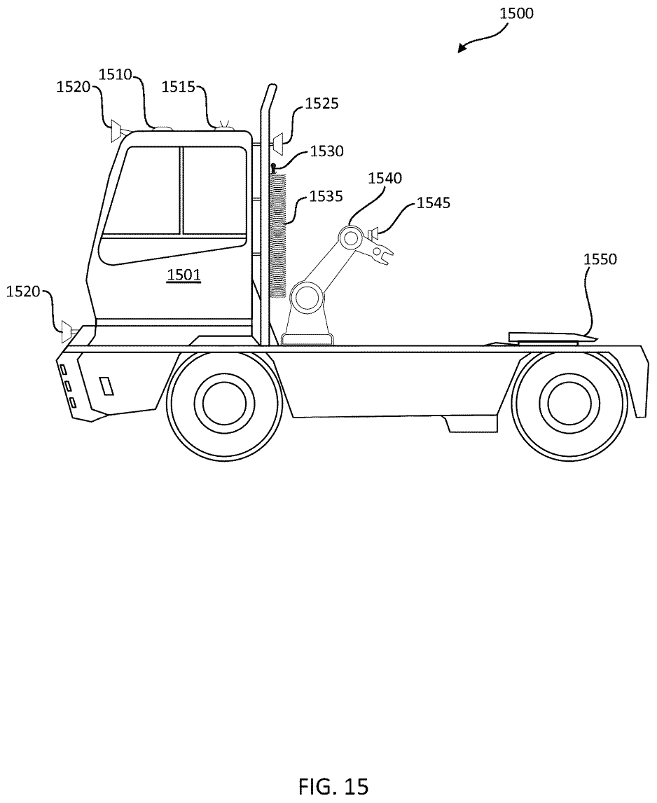

FIG. 15 is a side view of an autonomous yard truck 1500 according to some embodiments. The autonomous yard truck 1500 includes a cab 1501 that may be used to drive the autonomous yard truck 1500 manually. The autonomous yard truck 1500 may include one or more of the components shown in FIG. 14. The autonomous yard truck 1500 may also include a brake system, an engine, a transmission, steering, sensor array, etc. such as, for example, as shown in FIG. 14.

In some embodiments, the autonomous yard truck 1500 may include a sensor array that includes sensors 1520 (e.g., sensor array 1479) disposed at various locations on the autonomous yard truck 1500 such as, for example, on the cab 1501, bumper, housing, frame, etc. The sensors 1520 may include infrared sensors, ultrasonic sensors, magnetic sensors, radar sensors, LiDAR sensors, terahertz sensors, sonar sensors, cameras, etc. The autonomous yard truck 1500 may also include one or more backup sensors 1525 such as, for example, infrared sensors, ultrasonic sensors, magnetic sensors, radar sensors, LiDAR sensors, terahertz sensors, sonar sensors, cameras, etc.

In some embodiments, the autonomous yard truck 1500 may include a spatial locating device (or GPS) antenna 1510. In some embodiments, the autonomous yard truck 1500 may include a transceiver antenna 1515.

In some embodiments, the autonomous yard truck 1500 may include one or more hoses 1535 that can connect with a trailer such as, for example, two or three hoses. Each hose may have a hose connector 1530 that can connect with a trailer hose connector. For example, the one or more hoses 1535 of the autonomous yard truck 1500 may include a service brake hose, an emergency brake hose, and/or a refrigerant hose.

In some embodiments, the autonomous yard truck 1500 may include a robotic arm 1540 disposed on the back bed of the autonomous yard truck 1500. The robotic arm 1540 may include any type of robotic arm. The robotic arm 1540, for example, may exert high torque or high pressure sufficient to connect the hose connector 1530 with the trailer hose connector. The hose connector 1530 and/or the trailer hose connector may comprise a glad-hand connector. In some embodiments, when the autonomous yard truck 1500 is not coupled with a trailer, the hose connector 1530 may be positioned in a storage rack at some point on the autonomous yard truck 1500 such as, for example, on the rear of the cab 1501.

In some embodiments, the robotic arm 1540 may include one or more arm sensors 1545 such as, for example, infrared sensors, ultrasonic sensors, magnetic sensors, radar sensors, LiDAR sensors, terahertz sensors, sonar sensors, cameras, etc. The arm sensor 1545, for example, may produce data that can be used to identify the location of a hose connector 1530 and/or a trailer hose connector. The arm sensor 1545, for example, may produce data that can show that a hose connector 1530 and/or a trailer hose connector are sufficiently coupled.

In some embodiments, the autonomous yard truck 1500 may include a fifth-wheel coupling 1550. The fifth-wheel coupling 1550, for example, may be raised or lowered with a fifth-wheel coupling boom. FIG. 15 shows the fifth-wheel coupling 1550 in a lowered position. The fifth-wheel coupling 1550 may couple with a kingpin of a trailer.

When the fifth-wheel coupling 1550 is coupled with a kingpin and the fifth-wheel coupling 1550 is in the raised position, the legs of the trailer may lift off the ground (e.g., automatically). This may allow the autonomous yard truck 1500 to pull the trailer without individually raising the trailer legs.

In some embodiments, the robotic arm 1540 and/or the arm sensor 1545 may be coupled with a thermal management system. A thermal management system may, for example, be coupled with a thermal management system associated with the autonomous yard truck 1500 such as, for example, coupled with the cab heating/cooling system and/or the engine heating/cooling system. A thermal management system may, for example, be an independent system that heats and/or cools the robotic arm 1540 and/or the arm sensor 1545. A thermal management system may, for example, keep the temperature of the robotic arm 1540 and/or the arm sensor 1545 between about 32° F. and about 100° F.

In some embodiments, the autonomous yard truck 1500 may include a deployable shade coupled with the back of the cab 1501. The deployable shade, for example, may be used to screen the sun and/or other lighting from the arm sensor 1545 and/or the one or more backup sensors 1525. The deployable shade, for example, may include an umbrella configuration or an awning configuration. The deployable shade, for example, may be coupled with the roof or an upper portion of the cab.

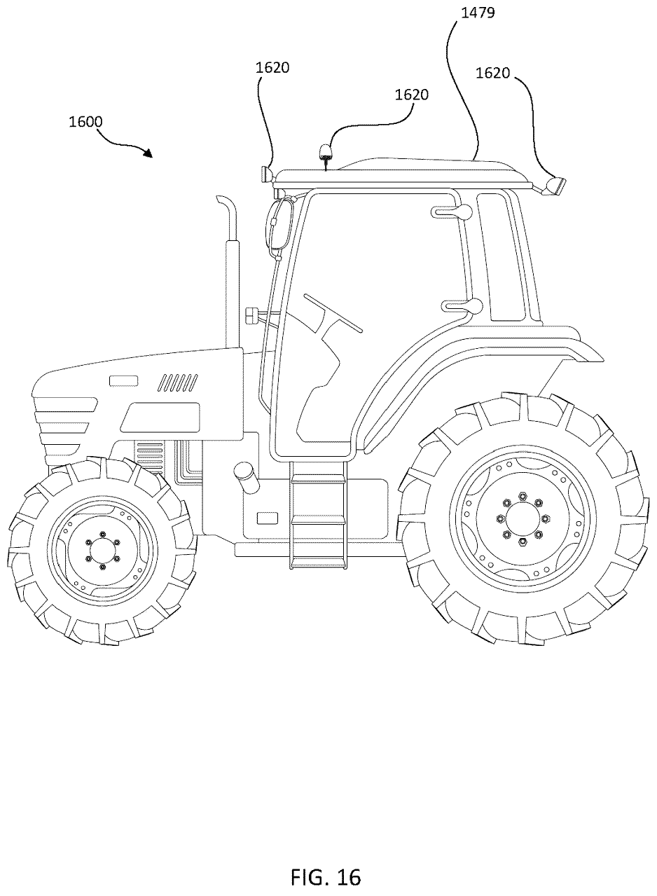

FIG. 16 is a sideview of an example autonomous tractor 1600, which may include all or some of the components of autonomous vehicle 1410 (or of autonomous vehicle 700 and/or autonomous tractor 400 described above). The autonomous vehicle in this document may include the autonomous tractor 1600. In this example, the autonomous tractor 1600 may include standard tractor equipment and/or components. The autonomous tractor 1600 may include or be coupled with any kind of implement such as, for example, a plow, disc plow, reel mower, dumper, lift, bucket, shovel, blade, and/or cutter, etc. The autonomous tractor 1600, for example, may include a sensor array 1479 (or multiple sensor arrays 1479), including sensor(s) 1620. The sensor array 1479 may include, for example, one or more LiDAR, radar, and/or video cameras. The video cameras, for example, may include 360 degree cameras, a front facing camera, and/or a back facing camera.

Numerous specific details are set forth herein to provide a thorough understanding of the claimed subject matter. However, those skilled in the art will understand that the claimed subject matter may be practiced without these specific details. In other instances, processes, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the processes disclosed herein may be performed in the operation of such computing devices. The order of the blocks presented in the examples above can be varied for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. An autonomous vehicle comprising:
a steering control system for autonomously controlling a driving direction of the autonomous vehicle;
a speed control system for autonomously controlling a speed of the autonomous vehicle;
one or more sensors, including a visual sensor;
one or more processors communicatively coupled with the one or more sensors, the steering control system, and the speed control system; and
one or more computer-readable media having stored thereon instructions that when executed cause the one or more processors to:
at a first time, receive first visual sensor signal data in predetermined time packets from the visual sensor, wherein a sensor field of view of the visual sensor includes a static surface of an operating environment and/or the autonomous vehicle,
at a second time, receive second visual sensor signal data in predetermined time packets from the visual sensor,
calculate a sensor reliability value associated with the visual sensor by comparing the first visual sensor signal data and the second visual sensor signal data, wherein the sensor reliability value represents a degree of difference between at least a portion of the static surface indicated by the first and second visual sensor signal data,
when the sensor reliability value is greater than or equal to a reliability threshold, instruct the steering control system and the speed control system to drive the autonomous vehicle along a path through the operating environment using the first and/or second visual sensor signal data, and
when the sensor reliability value is less than the reliability threshold, instruct the autonomous vehicle to enter a low-risk state.

2. The autonomous vehicle of claim 1, wherein comparing the first visual sensor signal data and the second visual sensor signal data when calculating the sensor reliability value comprises comparing a checksum of the first visual sensor signal data to a checksum of the second visual sensor signal data.

3. The autonomous vehicle of claim 1, calculating the sensor reliability value further comprises identifying a repeating pattern of sensor signal frames within the first and/or second visual sensor signal data.

4. The autonomous vehicle of claim 1, wherein the instructions further comprise illuminating the static surface with a pulsating light.

5. The autonomous vehicle of claim 1, wherein the visual sensor comprises a LiDAR sensor, a radar sensor, or a stereo camera.

6. An autonomous vehicle comprising:
a steering control system for autonomously controlling a driving direction of the autonomous vehicle;
a speed control system for autonomously controlling a speed of the autonomous vehicle;
one or more sensors, including a LiDAR sensor;
one or more processors communicatively coupled with the one or more sensors, the steering control system, and the speed control system; and
one or more computer-readable media having stored thereon instructions that when executed cause the one or more processors to:
receive point cloud data from the LiDAR sensor,
calculate a first dataset based on the point cloud data, wherein the first dataset comprises an odometry dataset that indicates at least one of a velocity, a velocity history, or a location of the autonomous vehicle,
receive a second dataset, wherein the second dataset comprises a GPS dataset and/or a wheel speed dataset and wherein the second dataset indicates at a velocity, velocity history, and/or location of the autonomous vehicle that corresponds to the velocity, velocity history, and/or location of the autonomous vehicle of the first dataset,
calculate a LiDAR reliability value associated with the LiDAR sensor by comparing the first and second datasets, wherein the LiDAR reliability value represents a degree of difference between corresponding data within the first and second datasets,
when the LiDAR sensor reliability value is greater than or equal to a reliability threshold, instruct the steering control system and the speed control system to drive the autonomous vehicle along a path through an operating environment based on the point cloud data, and
when the LiDAR sensor reliability value is less than the reliability threshold, instruct the autonomous vehicle to enter a low-risk state.

7. The autonomous vehicle of claim 6, wherein the point cloud data is produced from LiDAR sensor observation of a ground surface of the operating environment.

8. The autonomous vehicle of claim 6, wherein the point cloud data is produced from LiDAR sensor observation of a drive wheel of the autonomous vehicle.

9. The autonomous vehicle of claim 6, wherein entering the low-risk state comprises instructing the speed control system to stop the autonomous vehicle.

10. The autonomous vehicle of claim 6, wherein the instructions further cause the processor to:
calculate a wheel speed based on point cloud data; and
instruct the steering control system and the speed control system to drive the autonomous vehicle along a path through the operating environment based on the wheel speed.

11. An autonomous vehicle comprising:
a steering control system for autonomously controlling a driving direction of the autonomous vehicle;
a speed control system for autonomously controlling a speed of the autonomous vehicle;
an implement control system, including an implement;
one or more sensors, including a LiDAR sensor;
one or more processors communicatively coupled with the one or more sensors, the steering control system, the speed control system, and the implement control system; and
one or more computer-readable media having stored thereon instructions that when executed cause the one or more processors to:
at a first time, receive first LiDAR signal data in predetermined time packets from the LiDAR sensor, wherein the implement is within a sensor field of view of the LiDAR sensor and wherein the first LiDAR signal data indicates a position and/or orientation of the implement,
at a second time, instruct the implement control system to adjust the position and/or orientation of the implement,
at a third time, receive second LiDAR signal data in predetermined time packets from the LiDAR sensor, wherein the second LiDAR signal data indicates the position and/or orientation of the implement,
calculate a sensor reliability value associated with the LiDAR sensor by comparing the first LiDAR signal data and the second LiDAR signal data, wherein the LiDAR reliability value represents a degree of difference between the first and second LiDAR signal data,
when the sensor reliability value is greater than or equal to a reliability threshold, instruct the steering control system and the speed control system to drive the autonomous vehicle along a path through an operating environment based on the first LiDAR signal data and/or the second LiDAR signal data, and
when the sensor reliability value is less than the reliability threshold, instruct the autonomous vehicle to enter a low-risk state.

12. The autonomous vehicle of claim 11, wherein when the sensor reliability value is greater than or equal to the reliability threshold, the instructions further cause the processor to select a path through the operating environment based on the position and/or orientation of the implement.

13. The autonomous vehicle of claim 11, wherein when the sensor reliability value is greater than or equal to the reliability threshold, the instructions further cause the processors to instruct the implement control system to adjust a position and/or orientation of the implement based on a selected path of the autonomous vehicle.

14. The autonomous vehicle of claim 11, wherein the implement comprises a reflective surface.

15. The autonomous vehicle of claim 11, wherein the implement comprises a mower reel of the autonomous vehicle.

16. The autonomous vehicle of claim 11, wherein the position and/or orientation of the implement is determined based on a shadow of the implement indicated within the first and second LiDAR signal data.

17. The autonomous vehicle of claim 11, wherein the instructions further cause the processor to:
instruct the implement control system to adjust the position of the implement in and out of the sensor field of view; and
adjust the LiDAR reliability value of the LiDAR sensor such that:
when the implement is within a sensor field of view of the LiDAR sensor and the sensor signal data indicates that the implement is within the sensor field of view, increasing the LiDAR reliability value,
when the implement is within the sensor field of view and the sensor signal data indicates that the implement is not within the sensor field of view, decreasing the LiDAR reliability value,
when the implement is not within the sensor field of view and the sensor signal data indicates that the implement is within the sensor field of view, decreasing the LiDAR reliability value, and
when the implement is not within the sensor field of view and the sensor signal data indicates that the implement is not within the sensor field of view, increasing the LiDAR reliability value.

18. The autonomous vehicle of claim 11, wherein entering the low-risk state comprises instructing the speed control system to slow a velocity of the autonomous vehicle.

19. The autonomous vehicle of claim 11, wherein entering the low-risk state comprises sending a notification to a remote operator.

20. The autonomous vehicle of claim 11, wherein entering the low-risk state comprises slowing a movement of the implement, preventing movement of the implement, preventing the implement control system from operating the implement, or returning the implement to a closed or home position.

21-40. (canceled)
